(19) United States
(12) Patent Application Publication
(10) Pub. No.: US 2006/0206367 A1
(43) Pub. Date: Sep. 14, 2006

(54) Mission console

(76) Inventor: Douglas Leo Baker, Cumming, GA (US)

Correspondence Address: DOUGLAS LEO BAKER, 6815 GREEN FIELD LANE, CUMMING, GA, 30040, US

(21) Appl. No.: 11/363,788

(22) Filed: Feb. 27, 2006

Related U.S. Application Data
(60) Provisional application No. 60/656,278, filed on Feb. 25, 2005.

(51) Int. Cl. G06F 17/50

(52) U.S. Cl. 705/7

(57) ABSTRACT

The invention introduces a secure, graphical method and system for developing, analyzing, selecting, executing, measuring, and improving extensible, cohesive plans in single user, and multiple user environments. It presents a logical system for recycling plan related information. Mechanisms are introduced for brainstorming and collaborating during plan development and execution. Techniques for delegating, measuring, and accounting for plan targets are revealed. Methods for attaching strategies, analysis, media, and standard operating procedures to plan items are outlined. Administrations panels that control information flow between parties are exposed. A method for managing sub-projects that respond to challenges that surface during plan execution is presented. A method for alerting users to critical events is explained. Mechanisms for enhancing plan durability to improve the likelihood for target achievement are explained. A logical system for archiving and recycling information resulting from plan development and execution is disclosed. Tools for communicating plan progress and outcomes are introduced.

### BACKGROUND OF THE INVENTION

History is rich with examples of situations where people with common goals and motivations joined together in a synergistic manner to achieve phenomenal outcomes. A good example of this can be found in the 1940's. The allied success in World War II was largely influenced by the successful implementation of a formidable array of military and social strategies. In addition to worthy intelligence, effective communications, and a strong chain of command, American and European people bonded together and made substantial contributions to the development of the infrastructure that was critical to fighting the war.

Another example can be found in the 1960's. America's ability to put a man on the moon represented substantial will, dedication and determination on the part of astronauts, technicians, companies, the U.S. government, and American society in general. Although this was actually a period in the U.S. when many issues served to splinter society, much of America came together in a unified manner to mount a response to the Russian challenge.

Examples such as these bring to light the power humans possess when their passions and motivations intertwine with their creativity and ingenuity.

A common thread can be found in the examples above. In each of these cases people bonded together in a cohesive and constructive manner. Knowledge was shared. A strong, durable planning environment existed. People from all walks of life contributed to the development of solutions to a vast array of highly perplexing problems. This type of synergy is necessary in any situation in which seemingly insurmountable obstacles require the participation of a critical mass of people. Achieving this type of synergy, without question, requires the existence of a powerful, malleable communications infrastructure.

In the 21^{st} Century, our ability to respond to a number of dangerous and growing threats will be severely tested. Among them, in a shrinking world, competition for a dwindling base of resources will challenge us socially, economically, and politically.

Overcoming these challenges, similar to what was required in the 1940's and 1960's, will require a judicious mix of planning and problem-solving. It will also require that we capitalize on the existence of every tool at our disposal to communicate effectively, work together, work smarter, and innovate.

Fortunately, the foundation for accomplishing this already exists.

### BRIEF SUMMARY OF THE INVENTION

Check this to make each of these is covered with a description somewhere in the body of the document.

The present invention (also referred to herein as the “system” or “program”) enables users to develop project and sub-project based plans using a standard web browser. The means for establishing a unique identification system for the purposes of developing, storing, and retrieving project and sub-project information is outlined. The means for establishing a unique identification system for the purposes of developing, storing, and retrieving multiple levels of plan items, to include the ability to add new plan items at will is revealed. Accordingly, the means system for establishing a unique identification system for the purposes of adding project participants at will is revealed. The ability to attach unique identification numbers to participant groups, namely Enterprises, Organizations, Departments, Teams, for the purposes of developing, storing, and retrieving information related to these groups, is presented. The means for establishing a unique identification system for the purposes of developing, storing, and retrieving Strategies, Analysis, Media, and Standard Operating Procedures to projects is outlined. The means for establishing a unique identification system for the purposes of connecting projects with plan items is resident to the system, as is the means for establishing a unique identification system for the purposes of connecting projects and plan items with users. Accordingly, the means for establishing a unique identification system for the purposes of connecting projects, plan items, and users with strategies, analysis, media, and standard operating procedures is provided.

The means for establishing a unique identification system for the purposes of developing, storing, and retrieving new plan items, strategies, analysis, media, and standard operating procedures created during collaboration between users is described.

The means for establishing a unique identification system for the purposes of managing the Delegation of plan items to users and their associated plan items in a hierarchal and non-hierarchal manner is described.

A sub-system called edometers is revealed which establishes a method for attaching target achievement numbers to plan items, tracking those targets, communicating progress in an ongoing manner, and subsequently communicating project outcomes in a graphical and textual manner. A method for utilizing edometers to establish plan variances that notify project participants on distribution lists when targets are tracking outside of parameters set by users is outlined. A method for utilizing edometers to establish personal sensors that notify an owner of an item when that plan item is tracking outside of plan variances set by the plan item's owner is described. A definition for responding to parameter breaches by making adjustments to plan items for the purposes of bringing parameter breaches back within a plan's original specification is described.

A method for authorizing the sharing of plan information between users is provided.

### BRIEF DESCRIPTION OF THE SEVERAL VIEWS OF THE DRAWING

FIG. 1: Hosting the Application

FIG. 2: Internal Implementation

FIG. 3: Invention Process

FIG. 4: Primary Interface

FIG. 5: User Profile

FIG. 6: Project Profile, FIG. 6A. Transition Screen A, FIG. 6B: Transition Screen B

FIG. 7: Project Identification Structure

FIG. 8: User Administration

FIG. 9: Attachments Identification Structure

FIG. 10: Strategy Identification Structure

FIG. 11: Analysis Identification Structure

FIG. 12: Media Identification Structure

FIG. 13: SOP Identification Structure

FIG. 14: Long-term Strategy Form

FIG. 15: Medium-term Strategy Form

FIG. 16: Short-term Strategy Form

FIG. 17: Question Development Form

FIG. 18: Research Development Form

FIG. 19: SWOT Analysis

FIG. 20: Audio Attachment

FIG. 21: Blog Attachment

FIG. 22: Image Attachment

FIG. 23: Text Attachment

FIG. 24: Video Attachment

FIG. 25: Website Attachment

FIG. 26: SOP Attachment

FIG. 27: Project Attachments

FIG. 28: Communication

FIG. 29: Plan Item Development Form

FIG. 30: Plan Identification Structure

FIG. 31: Report

FIG. 32: Prioritization

FIG. 33: Deactivation

FIG. 34: Propose

FIG. 35: Vote

FIG. 36: Choose

FIG. 37: Delegate

FIG. 38: Dashboard

### DETAILED DESCRIPTION OF THE INVENTION

General System Architecture

Application Code Hosted by Internet Service Provider

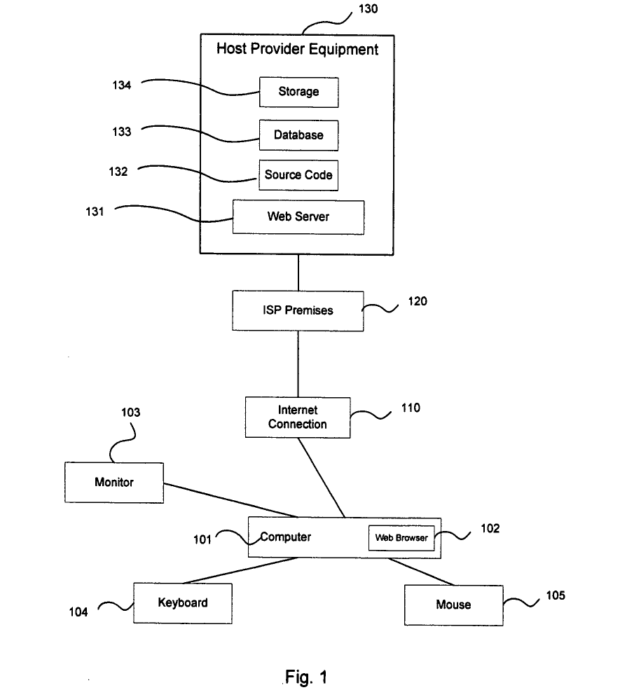

The present invention can be engaged in one of two unique computing environments. FIG. 1 shows the invention used in what is commonly referred to as a Hosted environment.

In a Hosted environment, the source code (FIG. 132) is accessed through an Internet Connection (FIG. 110) which provides access to the ISPs Premises (FIG. 120). Inside the ISPs facility, the invention is accessed through a Web Server (FIG. 131) installed on Host Provider Equipment (FIG. 130). Project participants use a Computer (FIG. 101) with a Web Browser (FIG. 102) installed on it to view the invention's resources via a Monitor (FIG. 103). They manipulate the invention using a Keyboard (FIG. 104) and Mouse (FIG. 105). The information they input into the system is organized using a Database (FIG. 133) and placed into a Storage device (FIG. 134).

Application Code Stored on Local Area Network

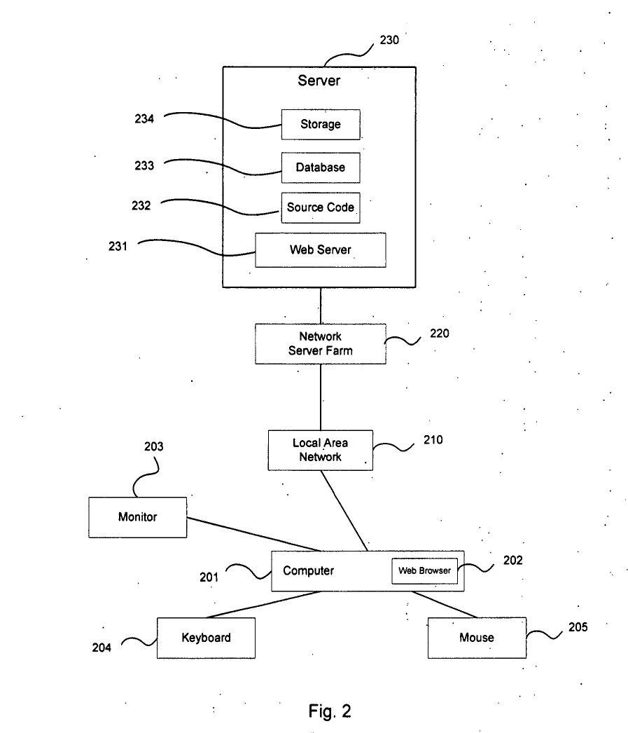

The present invention can also be engaged using a Local Area Network such as that in FIG. 2. The distinction between the methods employed in FIG. 2 versus FIG. 1 is that in FIG. 2 project participants gain access to the invention through a Local Area Network (FIG. 210) environment.

In a Local Area Network environment such as that in FIG. 2, Project participants access the source code (FIG. 232) using a Computer (FIG. 201) with a Web Browser (FIG. 202) installed on it to view the invention's resources via a Monitor (FIG. 203). They manipulate the invention using a Keyboard (FIG. 204) and Mouse (FIG. 205). The information they input into the system is organized using a Database (FIG. 233) and placed into a Storage device (FIG. 234). In this instance, the computer (FIG. 201) accesses the source code through a Local Area Network (FIG. 210) residing on premises. In this instance, calls to application functional are funneled through a situation similar to the Network Server Farm shown in FIG. 220. From this point, the Network Servers typically call on the Web Server (FIG. 231), installed on additional Network Servers (FIG. 230).

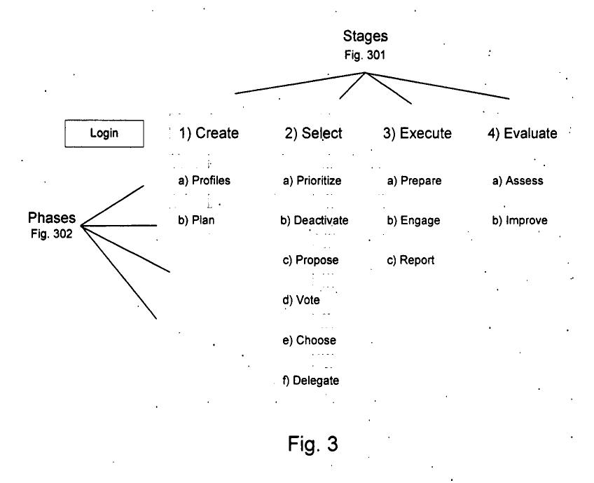

The present invention provides users in individual and multi-user settings with a standardized process for managing the development of plans. FIG. 3 provides a high-level view of the process employed from beginning to end when engaging the program. Running horizontally across the top of the process are Stages (FIG. 301) that users encounter. Running vertically below the Stages are Phases (FIG. 302) users employ before moving on to the next Stage.

The process revealed in FIG. 3 also represents a formidable problem-solving methodology. As such, sub-projects can be created and attached to plans that facilitate the management of challenges that surface during the execution of a plan.

Upon completing the process, users determine whether to enter into another iteration of the process. If the decision is made to engage in a new iteration of the process, information from the previous project is carried over to the next iteration. This approach introduces mechanisms for bringing continuous improvement to planning and problem-solving environments.

Prior to a step-by-step description of how the present invention is employed, it is helpful to become familiar with the interface used to engage the program.

Primary Interface

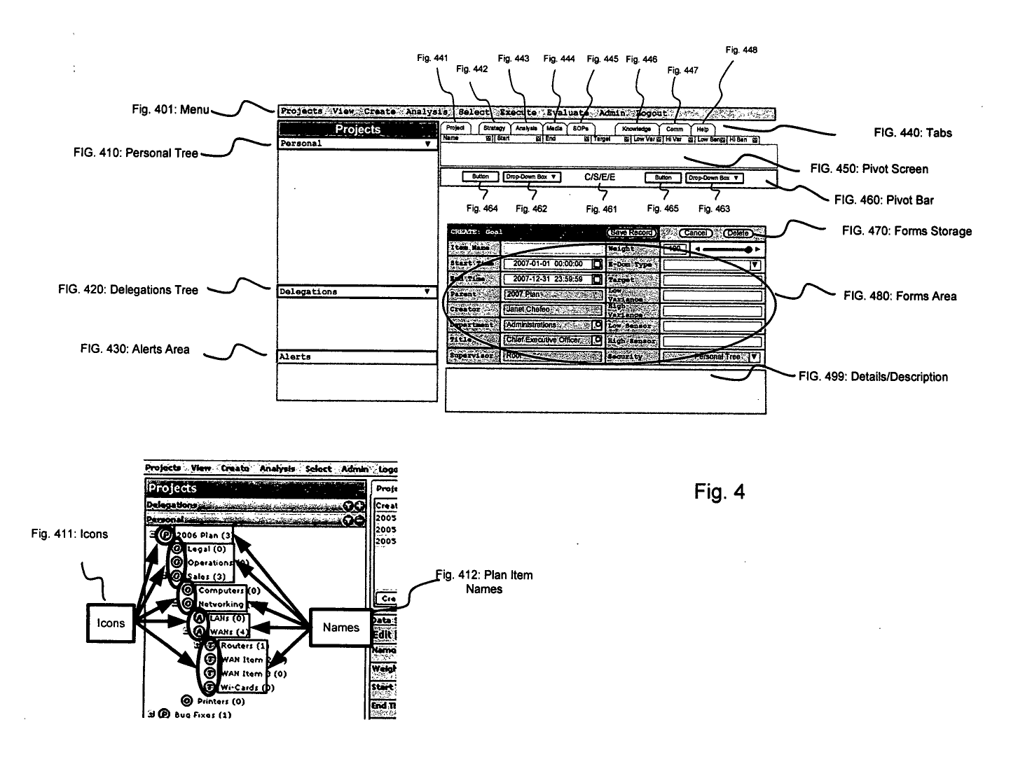

Employing a standard web browser installed on a computer, project participants access a graphical user interface (FIG. 4) to engage the program. This section of the description provides the reader with a snapshot of the key elements found on this interface.

Menu Items. Menu Items (FIG. 401) provide the means for accessing information and engaging various functional elements of the program. The specific Menu Items that are available at any point in time vary by the Stage and Phase of the program a user is in.

Planning Trees. Two Planning Trees list the names of plan items a user has saved. A Personal Tree (FIG. 410) provides the means for developing plans that remain private to the user. A Delegations Tree (FIG. 420) provides a Planning Tree which contains items that have been delegated to the user.

Alerts. Alerts (FIG. 430) notify users when:

1. The Start Date for a plan item the user owns is reached.

2. The End Date for a plan item the user owns is reached.

3. An Advance Notification is triggered by the Start Date of a plan item.

4. A plan item is Delegated to a user from another user.

5. A Discussion Item is sent to a user from another user.

6. A user is on the Distribution List of another user who has breached a Plan Variance.

7. A user has breached a Personal Sensor.

Tabs. Tabs (FIG. 440) work in conjunction with the Pivot Screen (FIG. 450) and Pivot Bar (FIG. 460). The Project Tab (FIG. 441) provides the ability to create new plan items, and view plan items. The Strategy Tab (FIG. 442), Analysis Tab (FIG. 443), Media Tab (FIG. 444), and SOP Tab (FIG. 445) are used to add specific Categories and sub-Categories of information to plan items. These Tabs are also used to view and access the information, by Category and sub-Category, that is added to plan items. The Knowledge Tab (FIG. 446) offers the means for searching projects and plan items to locate information. The Comm Tab (FIG. 447) provides the ability to communicate with users about plan items.

Pivot Screen. The Pivot Screen (FIG. 450) exhibits item lists, is used to manipulate lists of plan items, to delegate plan items, and to engage in collaboration items with other users regarding specific items.

Pivot Bar. The Pivot Bar (FIG. 460) contains Pivot Bar Buttons (FIGS. 464 & 465) and Drop-Down Selectors (FIGS. 462 & 463) that are used in conjunction with the Pivot Screen to create new plan items, to generate item lists, to manipulate plan items, to delegate plan items, and to collaborate with other users. Pivot Bar Hyperlinks (FIG. 461) are representative of the four Stages inherent to the Plan Development Process.

Forms Area. The present invention makes extensive use of forms to acquire information from users. The Forms Area (FIG. 480) is the section of the interface where these forms are presented to users. Forms are used to create plan items, attachments, and discussions. All information saved on a form is stored in a database for future retrieval.

Program Usage

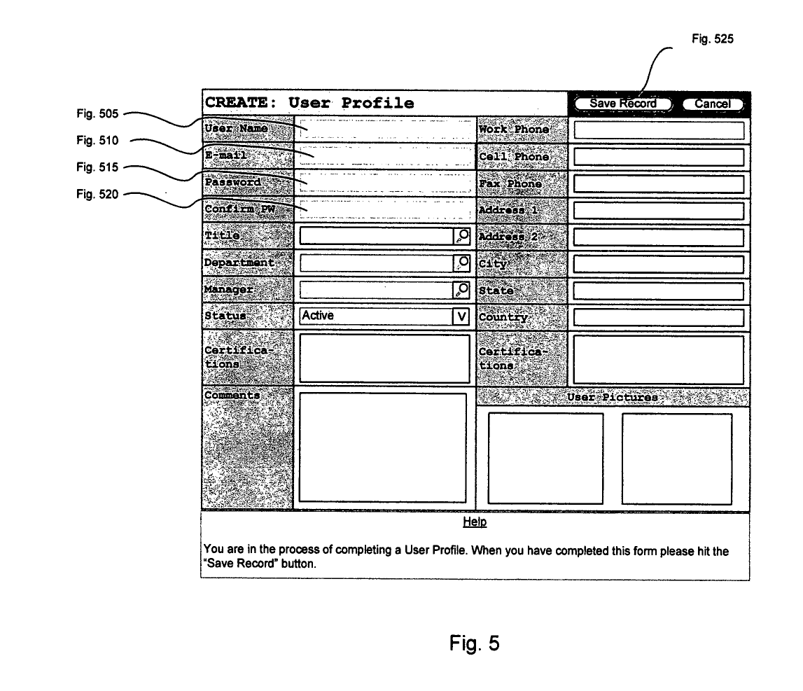

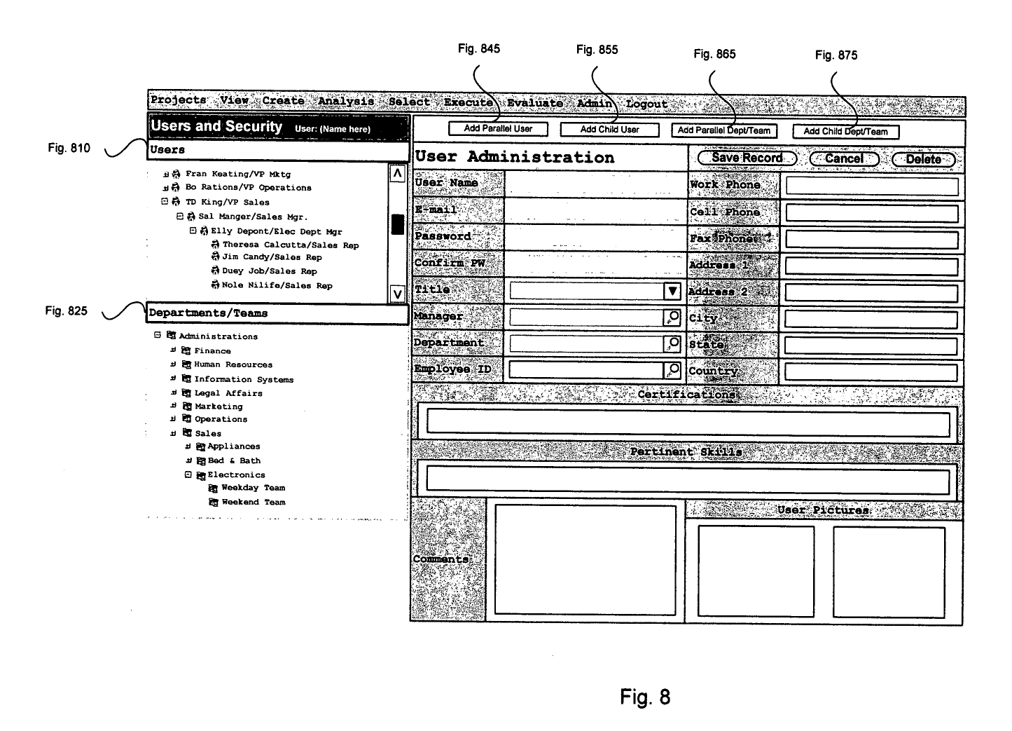

Program Entry. Users enter the program by logging in using a temporary username and password that is created by a system administrator through the User Administration Panel (FIG. 8). First time entrants to the system are presented with a User Profile (FIG. 5) upon entering the system. If this is a repeat visit for the user, they will be presented with the Primary User Interface (FIG. 4). Each time a user attempts to login to the program, the system performs a check to validate that a matching Email Address (FIGS. 510) and Password (FIG. 515) exist. If both of these are true, the user is provided entry.

User Profile. All users entering into a project create a User Profile (FIG. 5) User Profiles provide the system with a mechanism for creating, storing, and retrieving information that a user contributes to a project. User Profiles also gather contact information and pertinent background information about users and communicate this information to other project participants.

Users are required to complete the following fields on the User Profile:

User Name. The User Name (FIG. 505) field represents the screen name that is presented on a monitor by the system when referring to a user.

Email Address. The Email Address (FIG. 510) entered into this field specifies a location external to the system where the user wishes to receive notifications and/or electronic mail that is directed to them. The system also reconciles the user's Email Address against their Password (FIG. 515) in future logins to confirm the user's identity and provide them with entry into the system.

Password. Users entering into the system for the first time are required to change their Password (FIG. 515). Users are required to enter this Password at login to reenter the system. The system reconciles a user's Email Address (FIG. 510) and Password to verify they are authorized to reenter the system.

Confirm PW: Users entering into the system for the first time are required to confirm their new password (FIG. 520).

User Identification. When the Save Record (FIG. 525) button is pressed on the User Profile the system assigns a unique user identification number to the user. This number is invisible to the user. This number is used to identify users, record the information they create, and reproduce this information to users possessing the authorization to view it.

New fields can be added to the User Profile to suit the needs of the plan and situation. A variety of sample field names that might be included are provided in FIG. 5. Optional fields that are added to the User Profile, as with optional fields added to any and all forms on the system, become accessible when that form is retrieved by the system.

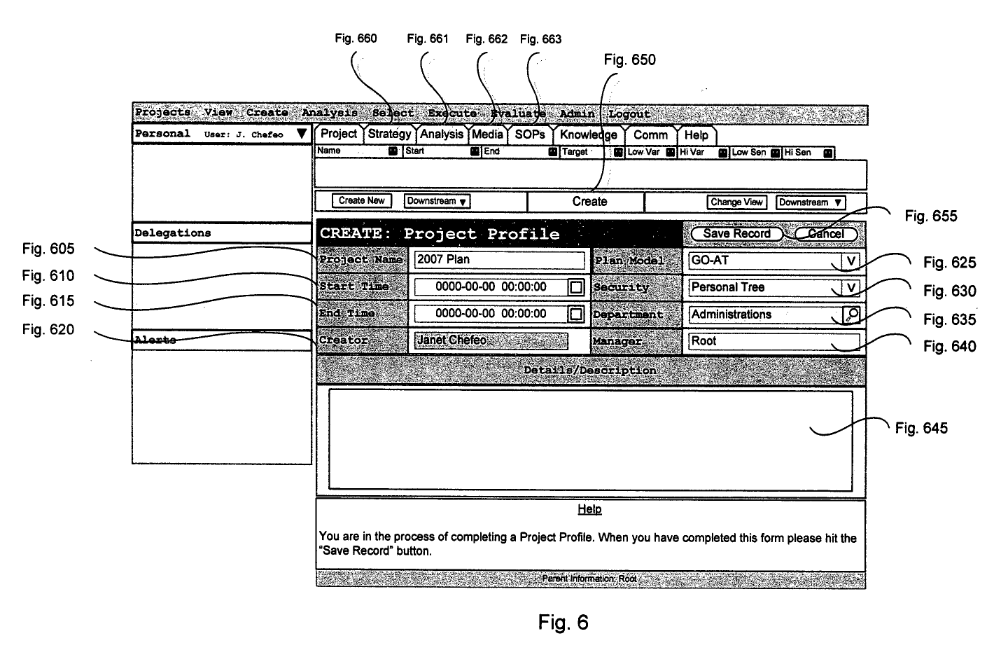

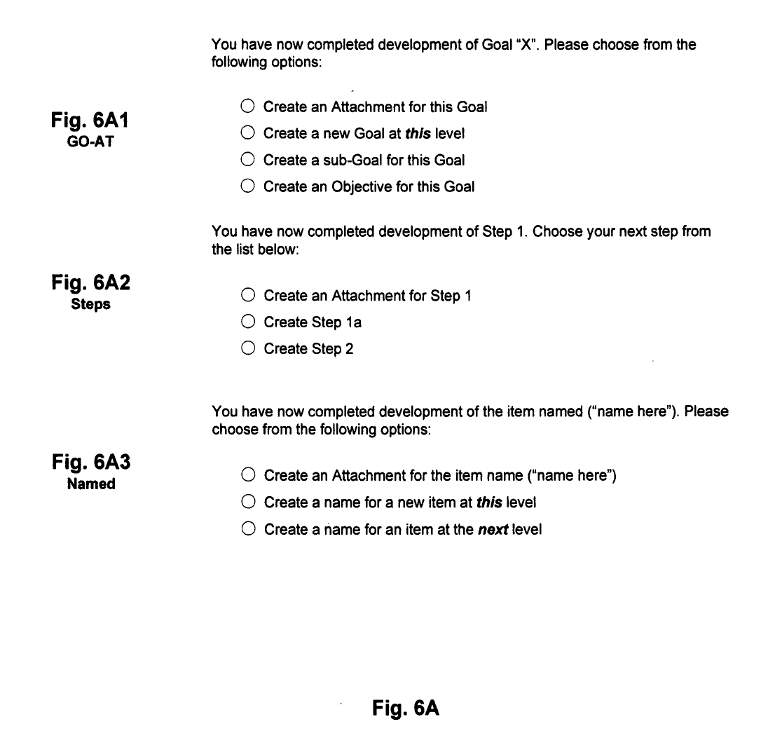

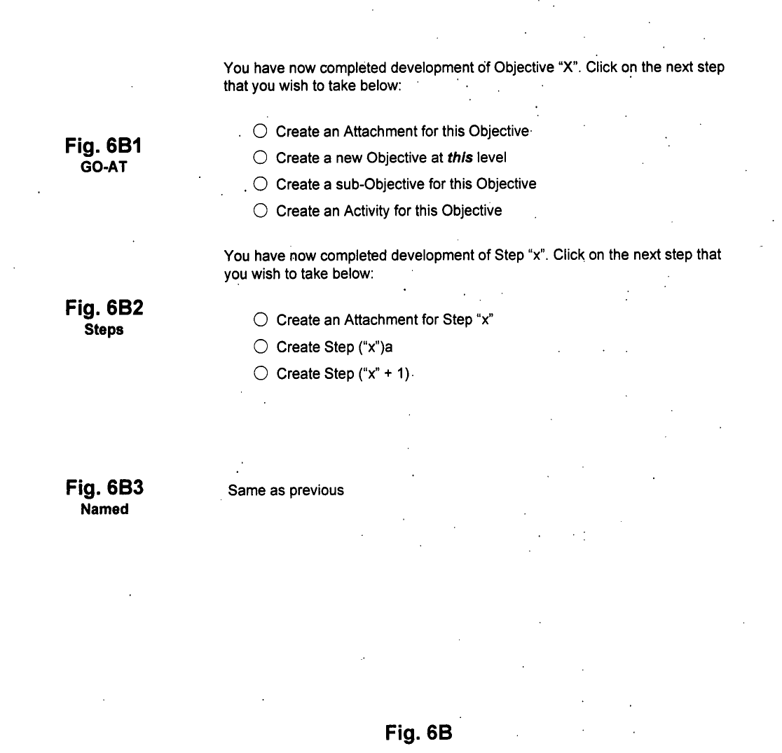

Project Profile. Users who initiate new projects must complete a Project Profile (FIG. 6). In a new installation of the program, a Project Profile is completed immediately after the User Profile is completed. After this point, Project Profiles are completed when “Project/New” is selected from the Menu (FIG. 401). One Project Profile is completed per project. Project Profiles provide the system with the elements for creating, storing, and retrieving information contained within the project. Project Profiles are also used to communicate background information to users about the project. When users are completing Project Profiles “Create” (FIG. 650) appears in the center of Pivot Bar.

Users are required to complete the following fields on the Project Profile:

Project Name. A Project Name (FIG. 605) is a required field on the Project Profile. The Project Name represents the description the system presents on a computer monitor when referring to the Project. This approach is used to provide users with an intuitive method for referring to projects.

Start Time. A Start Time (FIG. 610) on a Project form is created by the user. The Start Time designates the beginning date and time for the project. The Start Time triggers the system to begin the project when the Start Time is reached.

End Time. An End Time (FIG. 615) on a Project form is created by the user. The End Time designates the date and time the project comes to a close. The End Time triggers the system to end the project when the End Time is reached.

Plan Model. The Plan Model (FIG. 625) is determined by the creator of the project. The Plan Model is used to describe plan items. Three primary models are available, namely GO-AT, Steps, and Named.

GO-AT as Plan Model. Selecting GO-AT as the Plan Model will provide users with the opportunity to develop Goal, Objective, Activity, and Task plan items, along with sub-items within each of these items described as sub-Goals, sub-Objectives, sub-Activities, and sub-Tasks. When a user chooses to create a new plan item, the system automatically presents the user with a set of options specific to the Model they are employing. As an example, FIG. 6A1 provides the opportunity to select from sub-Goals and Objectives. Upon creating items at the Objectives level, this screen will transition to that in FIG. 6B1. This process will continue through the Activity and Task levels.

Steps as Plan Model. Selecting Steps as the Plan Model will provide users with the opportunity to develop plan items that are numbered in a sequential fashion (FIG. 6A2). These pages can be adapted, for example, to facilitate outlined numbering.

Name as Plan Model. Selecting Name as thee Plan Model (FIG. 6A3) gives users the opportunity to input a name for the plan item they are creating.

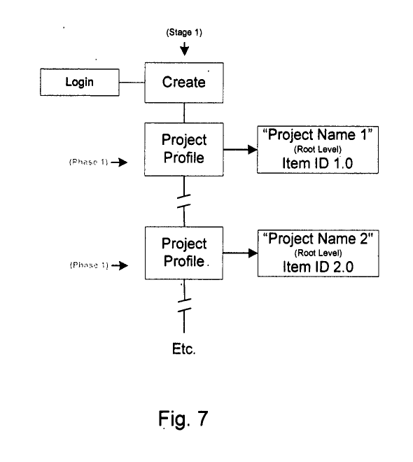

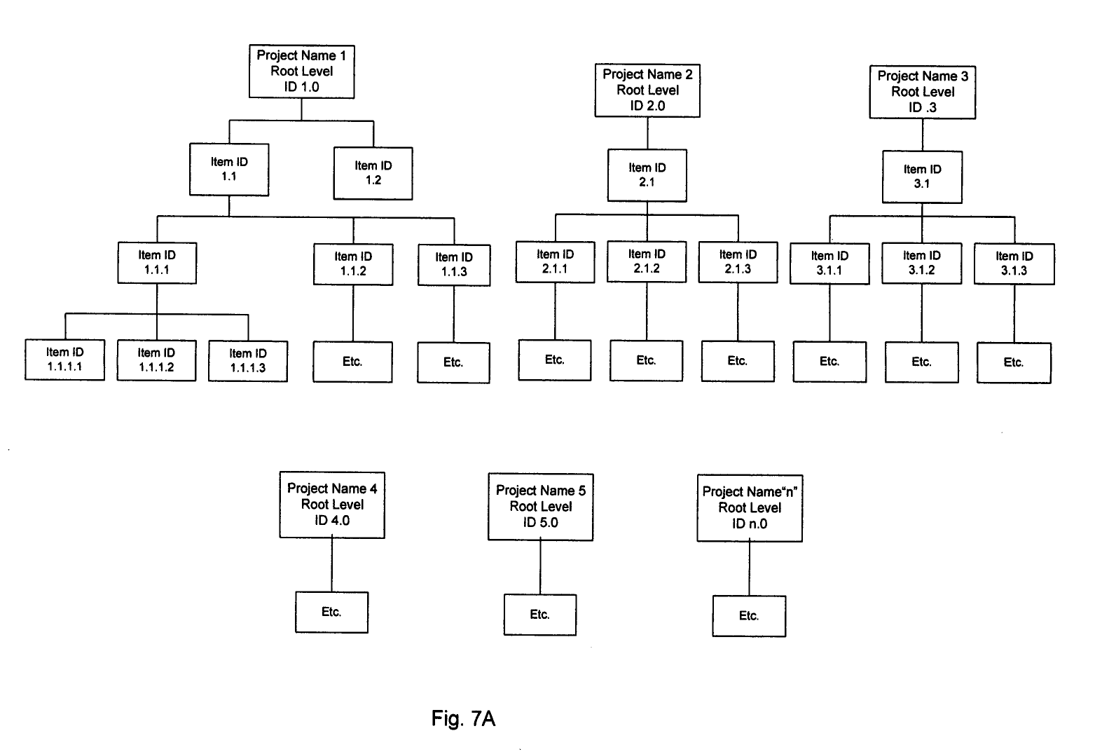

Project Identification. When the Save Record (FIG. 655) is pressed on the Project Profile, the system creates a unique Project Identification Number (FIG. 7) and assigns it to the Project Name. This number is invisible to users. The Project Name has a direct relationship with its unique Project Identification Number (FIG. 7). Each Project Name can have only one Project Identification Number associated with it (FIG. 7A), and each Project Identification Number can have only one Project Name associated with it. The system uses Project Identification Numbers to create, store and retrieve information contained within projects.

Projects reside at the “root”, or top of the plan model. When a user saves a Project Profile the Project Name placed in this field is listed on the users Personal Planning Tree (FIG. 412), along with an Icon (FIG. 411) based on the Plan Model employed in the project. Users reentering the system are presented with a list of the project names and icons on their Personal Planning Tree.

Creator. The Creator (FIG. 620) of a project is automatically inserted into this field by the system. This field cannot be changed. The system reconciles the User's Identification Number with the participants User Name (FIG. 505) to acquire this information.

Security. The Security (FIG. 630) field communicates to the user the current state of viewing authorizations for the item. This field is managed by the system. Potential settings for this item are Private, Personal Tree, Delegated, and Shared.

Manager. The Manager (FIG. 640) field is used to communicate the hierarchy specific to this project. This field is managed by the system. The information inputted into this field is taken from the configuration employed in FIG. 810.

Details/Description. The Details/Description field (FIG. 645) field is an element common to all forms. This area provides users with an opportunity to attach background information of various types to the item.

Department. The Department (FIG. 635) field is an optional element on the Project Profile. In this instance, the Department field communicates the specific department the user who initiated the project works in. In this configuration, the information in this field is managed by the system using the information created in FIG. 825.

Creating New Projects. New projects are creating by selecting Project/New from the menu (FIG. 401) drop-down list. This will present the user with a blank Project Profile form.

Management Profile. Once a Project Profile has been completed by the Creator of a project, the Creator can, at their option, begin adding new users to the project. New users are added to projects using the Administrations Panel (FIG. 8). The Administrations Panel is accessed by selecting Admin/Users from the menu (FIG. 401) drop-down list.

Adding parallel users is accomplished by first clicking on the name of any person residing at the same level as the user being added. Next, the user clicks on the “Add Parallel User” (FIG. 845) button. This will produce a blank User Profile. Next, the user is required to input a User Name, Email Address, and temporary Password for the new user. The Email Address and Password entered here become the login information typed in by the new user to gain entry into the system and join the project.

Adding subordinate users is accomplished by first clicking on the name of the supervisor of the subordinate being added. Next, the user clicks on the “Add Child User” (FIG. 855) button. This will produce a blank User Profile. Next, the user is required to input a User Name, Email Address, and Password for the new user. The Email Address and Password entered here become the login information typed in by the new user to gain entry into the system and join the project.

Project participants with the authority to introduce new users to the project can add them at any time during the course of a project. All new users that are brought into a project must complete a User Profile upon logging in for the first time. It is not necessary that multiple users participate in a project as the program can be employed in a single user environment.

Department Administration. Department Administration is managed within the User Administration Panel (FIG. 825). New departments and teams can be created by those with the authorization to do so. The terms department and team are used interchangeably as the system treats them in the same manner, i.e., it makes no difference if a new addition is called Finance or Northern Sales.

Adding Parallel Departments and Teams is accomplished by first clicking on a department name at the same level as the Department being added. Next, the user clicks on the “Add Department” (FIG. 865) button. This will produce a blank Department Profile form. The Department Name field is the only required field that must be completed on this form. Other fields can be added to Department development forms as needed.

Adding Child Departments and Teams is accomplished by first clicking on the Department of the supervising Department. Next, the user clicks on the “Add Child Dept/Team” (FIG. 875) button. This will produce a blank Department Profile form. The Department Name field is the only required field that must be completed on this form. Other fields can be added to Department development forms as needed.

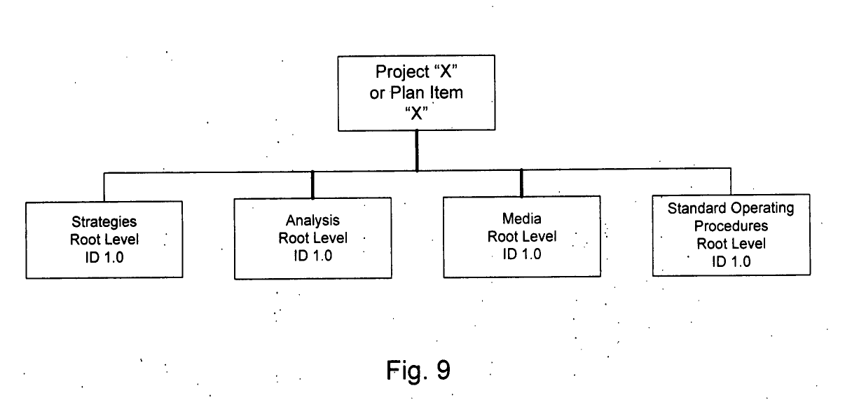

Attachments. Saving a Project Profile (FIG. 650) provides a user with the functionality to add Strategies (FIG. 660), Analysis (FIG. 661), Media (FIG. 662), and Standard Operating Procedures (FIG. 663) to that Project Name. These Tabs are commonly referred to in the Invention Description as Attachments. Each of the four categories of Attachments represents an entity in and of itself. Each Attachment category is given a unique identification number (FIG. 9) which associates it directly with the identification number assigned to the Project Name. All identification numbers are invisible to users.

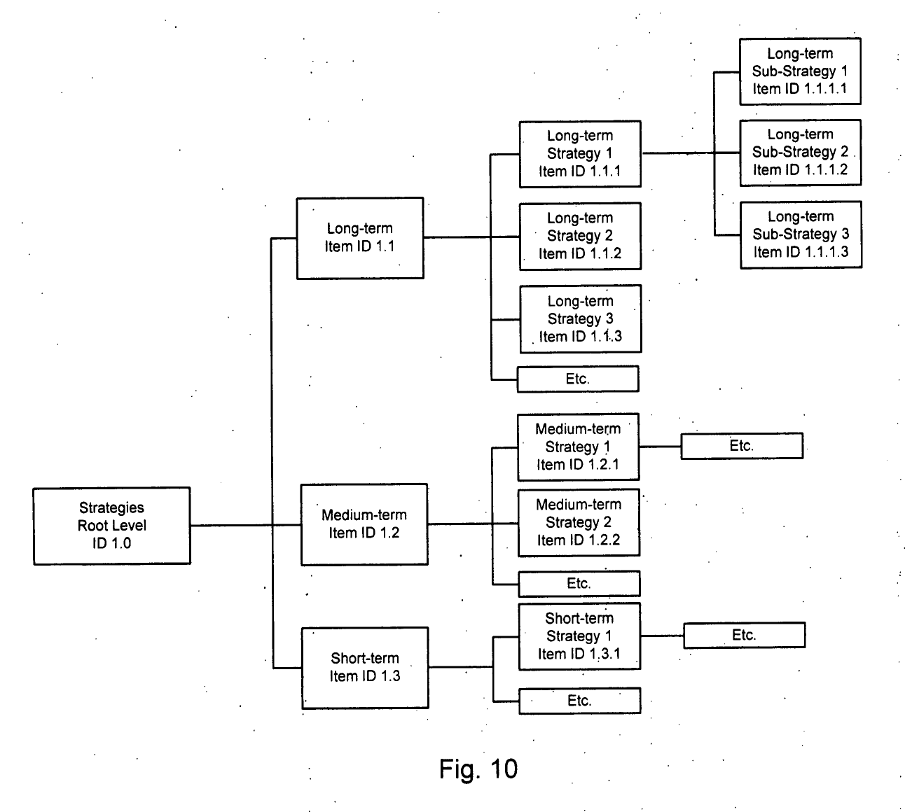

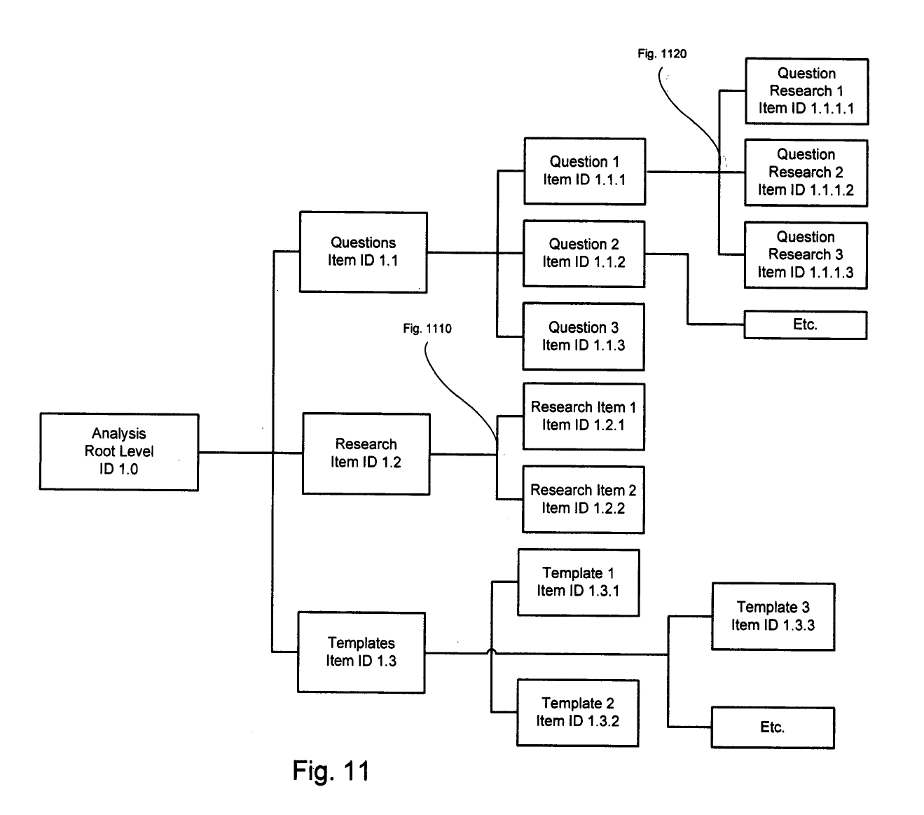

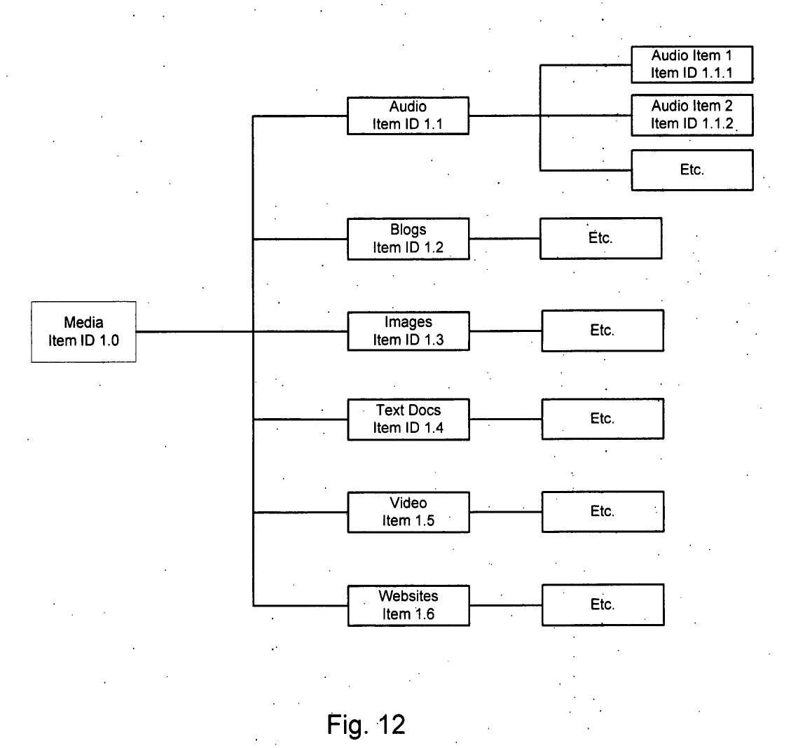

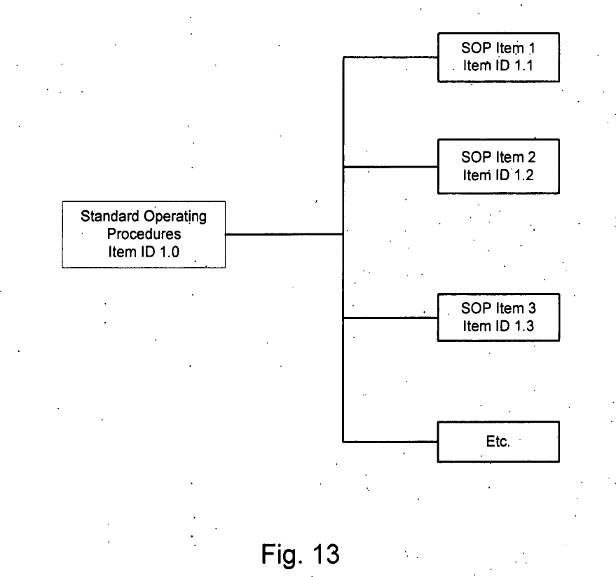

Attachment categories can also contain sub-categories which are entities in of themselves (FIGS. 10, 11, 12, 13) Attachment sub-categories are given unique identification numbers. The identification number assigned to the sub-category associates it directly with the identification number assigned to its parent category.

Each attachment category of contains the following sub-categories that users can select from.

Strategies. Three different Strategy options can be added to Project Names, including Long, Medium, and Short-term strategies. Sub-items can also be added to each Strategy sub-Category. Strategy items can be measured using Edometers.

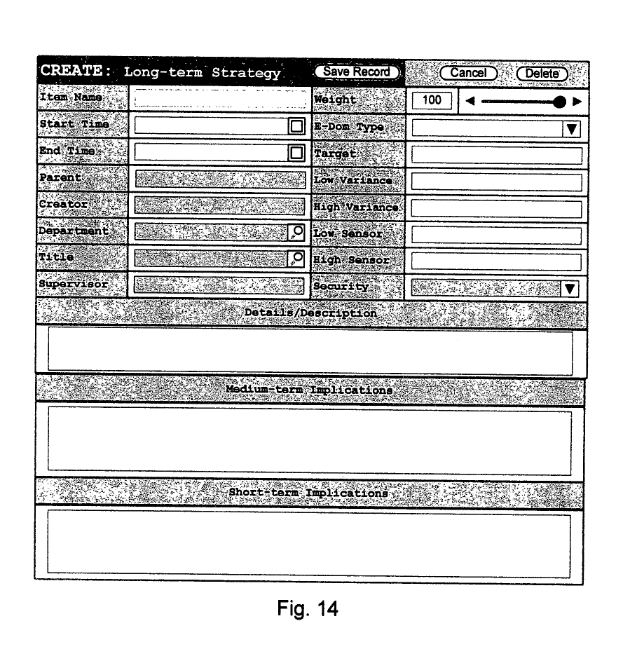

Long-term Strategies. Long-term Strategies are added to Project Names using Long-term Strategy Development Forms (FIG. 14)

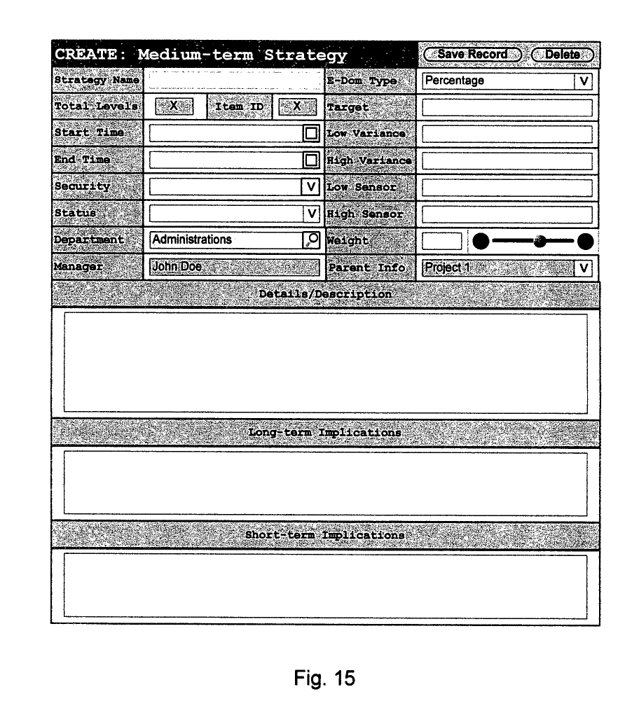

Medium-term Strategies. Medium-term Strategies are added to Project Names using Medium-term Strategy Development Forms (FIG. 15)

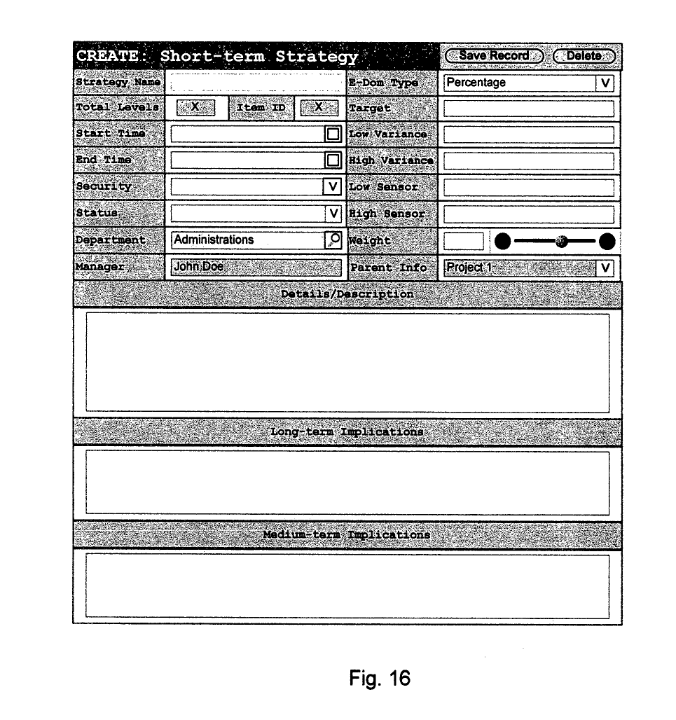

Short-term Strategies. Short-term Strategies are added to Project Names using Short-term Strategy Development Forms (FIG. 16)

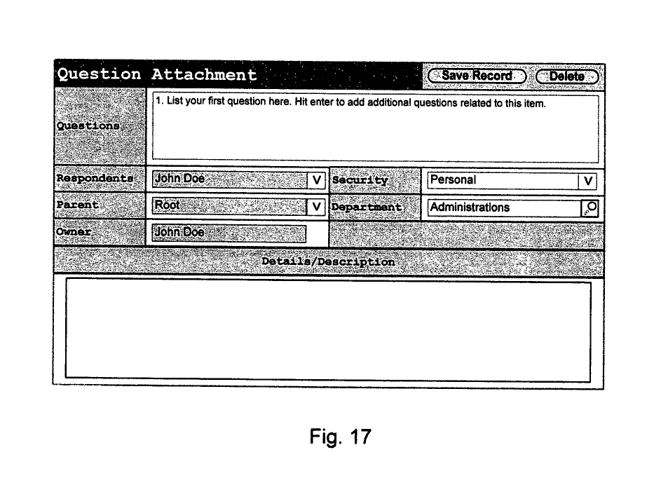

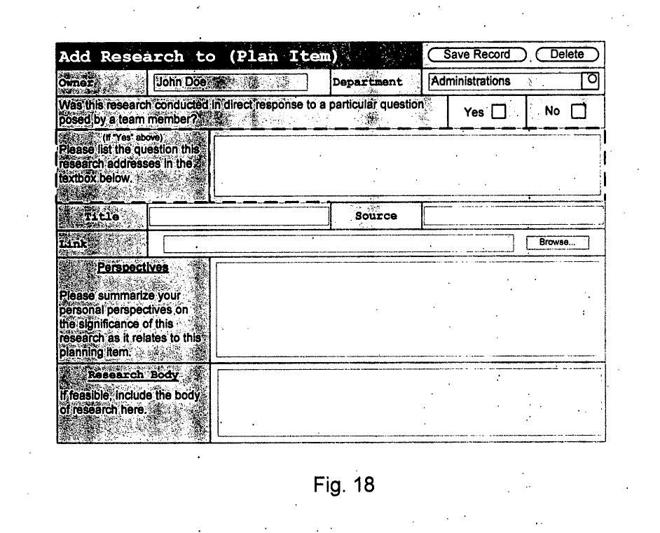

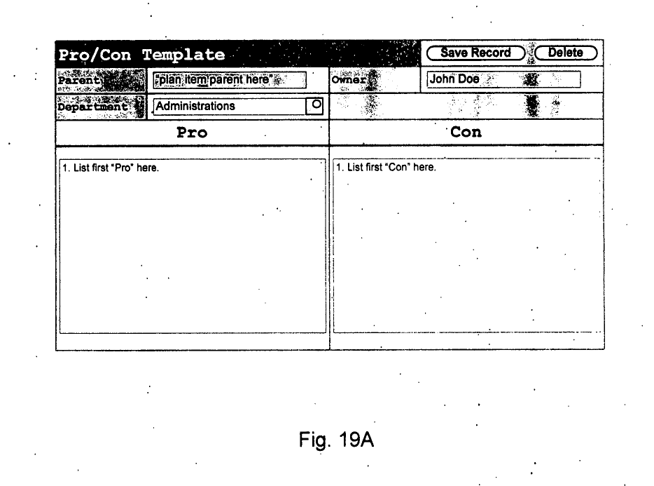

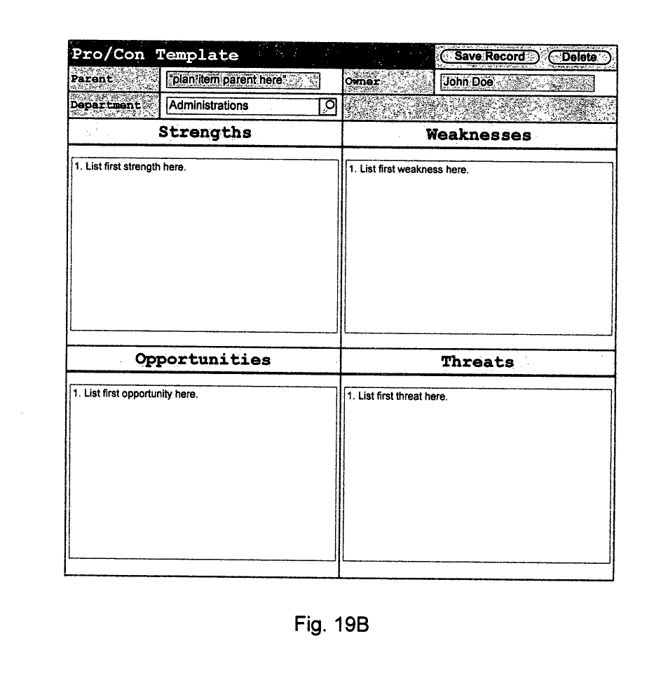

Analysis. Three different types of Analysis items can be added to Project Names, including Questions (FIG. 17), Research (FIG. 18), and Templates (FIGS. 19A & 19B). Questions provide the ability to request information. The Research option can be used in two ways. First, it offers the opportunity to attach research to plan items (FIG. 1110). And second, Research items can be attached to questions (FIG. 1120) posted by users in an effort to provide information that increases the likelihood the project will succeed.

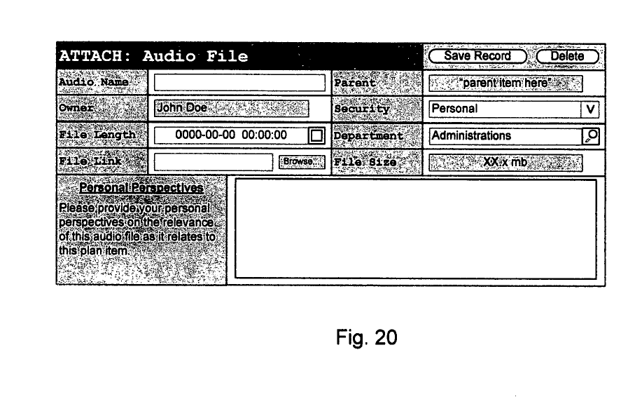

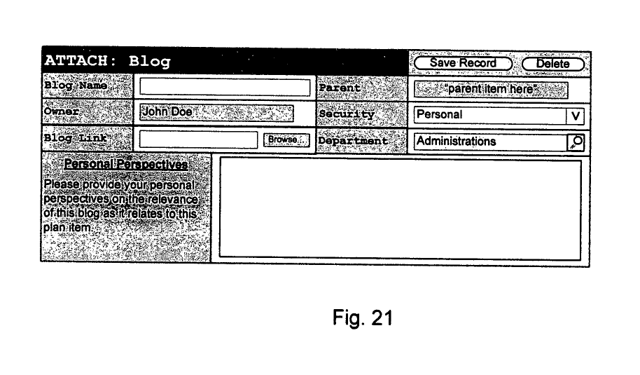

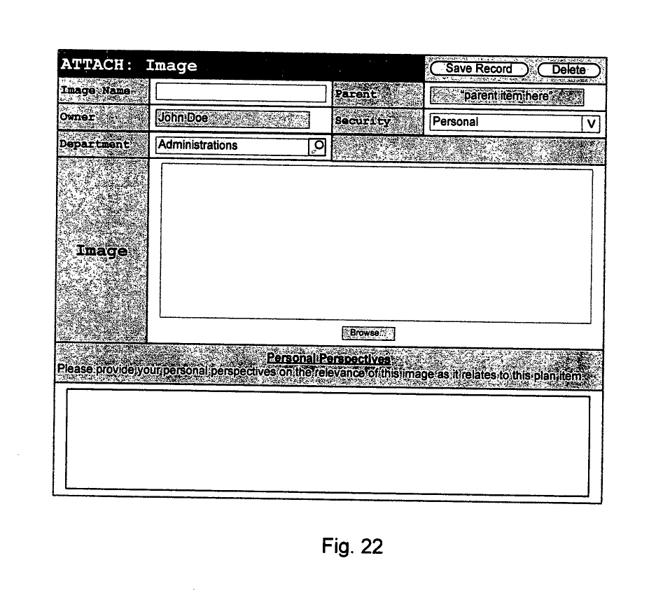

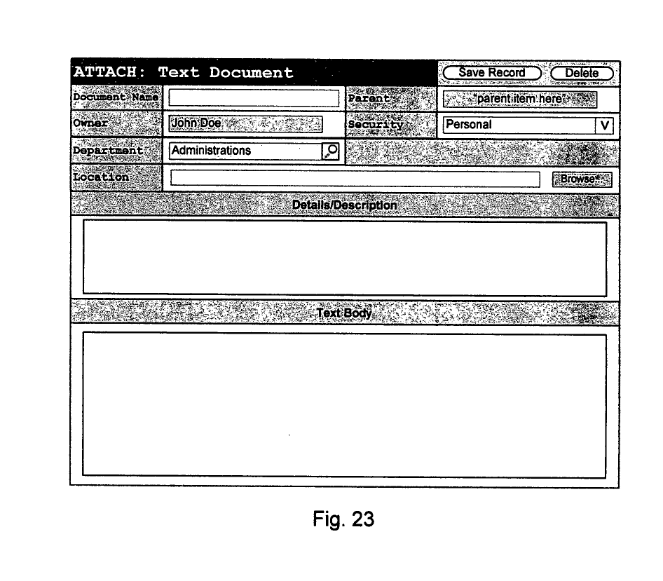

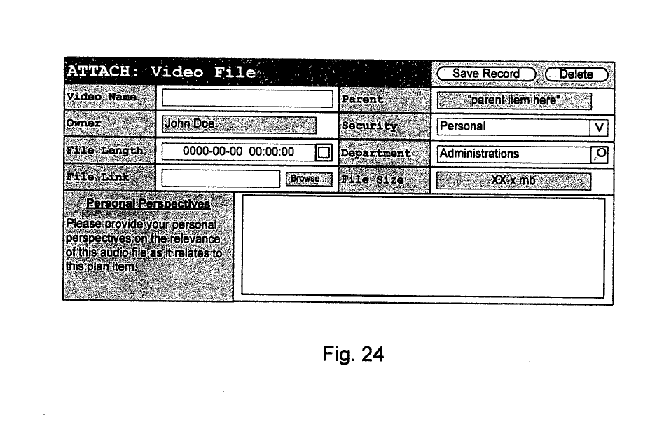

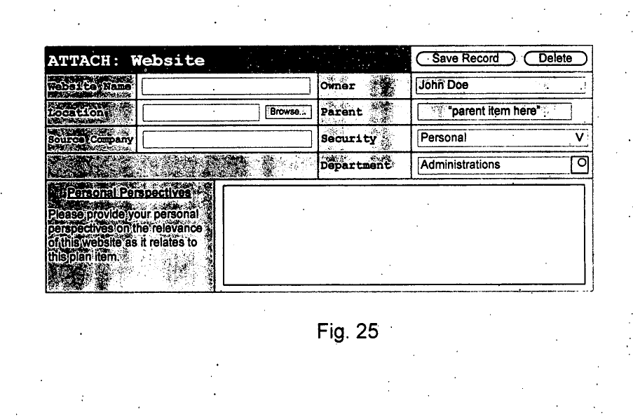

Media. Media items can be added to projects with the intent to communicate with the project team using the most effective medium possible. Six different types of media can be added to plan items. Audio (FIG. 20) can be added to items so that auditory information can be used. Blogs (FIG. 21) can be added so that Internet discussions can be added to items. Images (FIG. 22) can be added to items so that pictures can be used to communicate graphical matter. Text Documents (FIG. 23) can be added to items so that large bodies of text based information can be included. Video (FIG. 24) can be added to items so that pertinent websites containing large bodies of information can be included. Websites (FIG. 25) can be added so that film related information can be included.

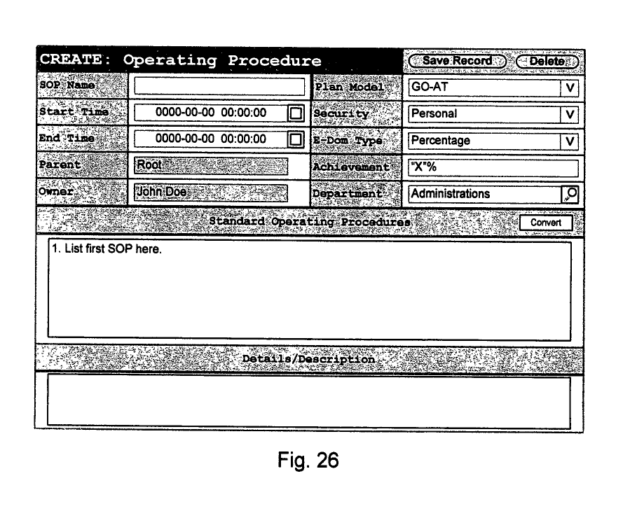

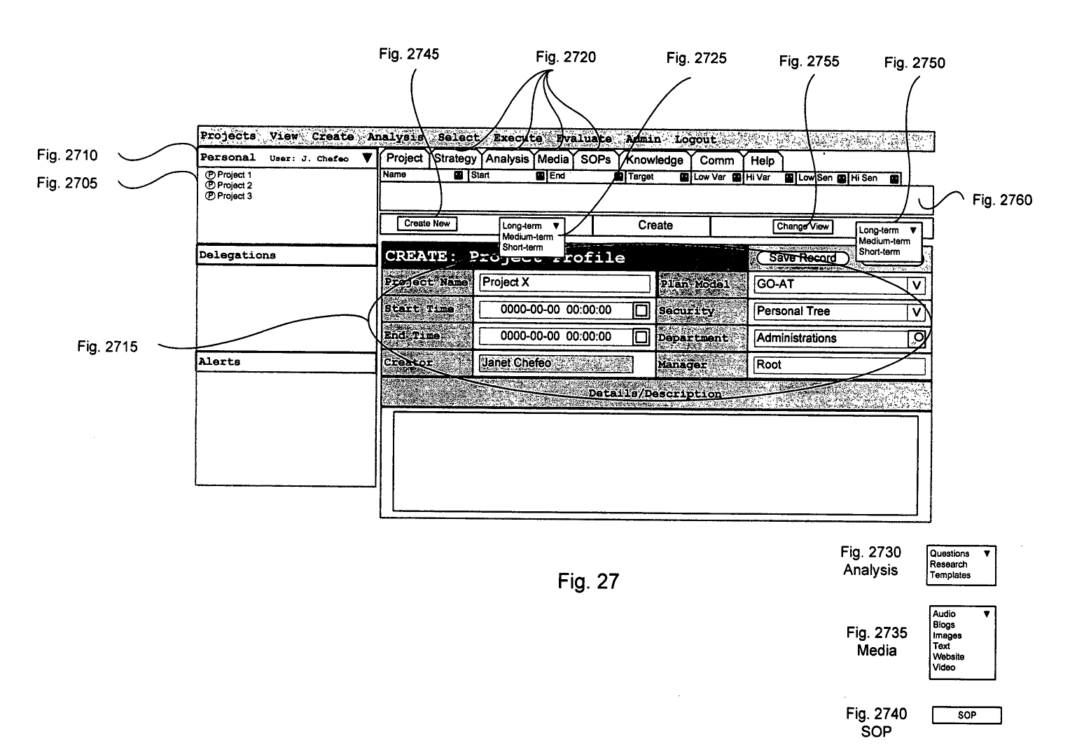

Standard Operating Procedures. Standard Operating Procedures (FIG. 26) (SOPs) can be added to projects to communicate details pertaining to how a specific plan is to be implemented. SOPs serve differing purposes depending on the level of the plan item they are attached to. When used at the parent level, SOP items serve as a guide to communicate child processes that will be employed to achieve the Target specific to the Parent. In this instance, the user is provided with a “Convert” Button that will convert each of the child processes into a plan item at the next level. In this instance, the name of the item will be used to create a field name in the database, which will in turn be used to create a unique identification number for that item. At the child level, SOP items serve to communicate specific detail related to the achievement of what amounts to the lowest level in the plan, such as a company policy that has been put in place to guide standards of conduct.

Creating New Attachments. Attachments are added to Project Profiles by first clicking on the desired Project Name (FIG. 2705) on the Personal Planning Tree (FIG. 2710). This will produce the appropriate Project Profile in the Forms Area (2715). The next step is to select the desired Attachment from one of the four Attachment Tabs (2720), namely the Strategy, Analysis, Media, or SOP Tab. The Tab the user clicks on will cause the Left Drop-Down Selector (FIG. 462) to offer sub-categories specific to the Tab the user has chosen. FIG. 2725 provides an example of the choices on the Left Drop-Down Selector that would be made available to the user when selecting the Strategy tab. FIG. 2730 provides an example of the choices on the Left Drop-Down Selector that would be made available to the user when selecting the Analysis tab. FIG. 2735 provides an example of the choices on the Left Drop-Down Selector that would be made available to the user when selecting the Media tab. FIG. 2740 provides an example of the choice that would be made available to the user when selecting the SOP tab. There are no SOP sub-categories available, hence only one type can be engaged. Once a user has selected their desired sub-category, they must click on the Create New (2745) button which is found to the left of the Drop-Down Selector that is implemented. This will generate the appropriate Attachment Development Form (FIGS. 14-26) in the Forms Area. At this point, the user completes the Form and saves the record. In the event the user exits the screen without saving the form, as a safeguard they will be presented with a dialogue box asking them if they wish to save their information. Clicking on the “yes” option will save the information the user placed on the form, clicking so will discard the information.

Accessing Attachment Lists. Generating lists of the information that has been saved on Attachment forms is accomplished by employing the Right Drop-Down Selector (FIG. 2750) in conjunction with the Change View button (FIG. 2755). The functionality inherent to FIGS. 2750 and 2755 work much like the functionality inherent to FIG. 2725 and FIG. 2745. The user first clicks on the Project Name containing their list of desired Attachments. The Attachments shown in the Pivot Screen will be those that are directly associated with the identification number assigned to the specific Project Name. Next, the user must click on their desired Attachment Tab (FIG. 2720). Next, the user must make a choice on the Right Drop-Down Selector designating the pertinent sub-Category of Attachment (FIG. 2750, 2730, 2735, 2740) they wish to list. Next the user will click the Left Pivot Button (FIG. 2755) labeled Change View. This will produce the appropriate list of Attachment items in the Pivot Screen (FIG. 2760). The name of the attachment will be presented to users as a hyperlink in the Pivot Screen. The user can produce a record of that item in the Forms Area by clicking on this hyperlink.

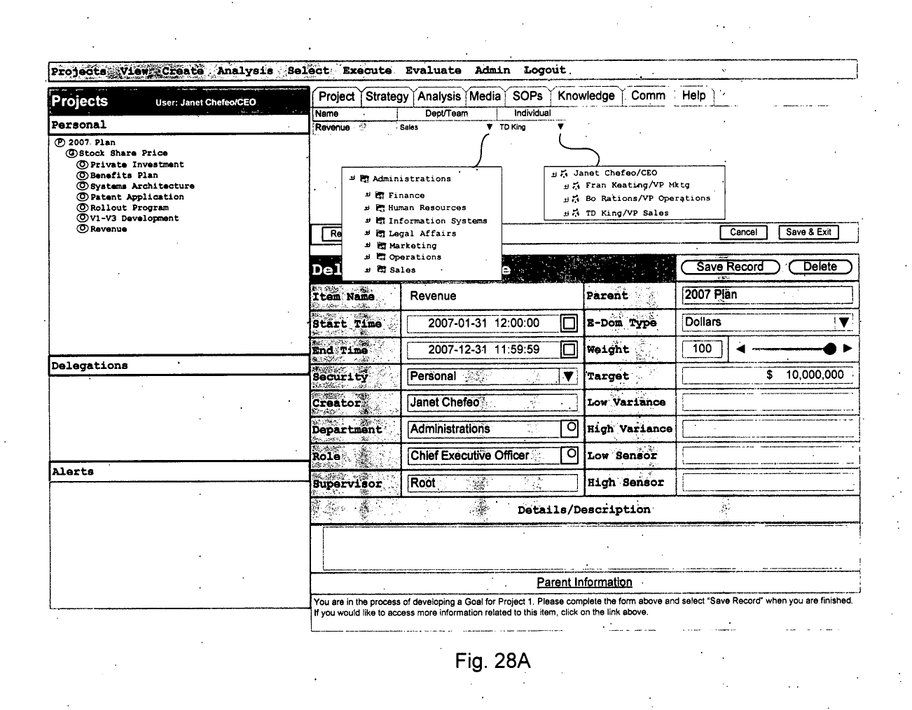

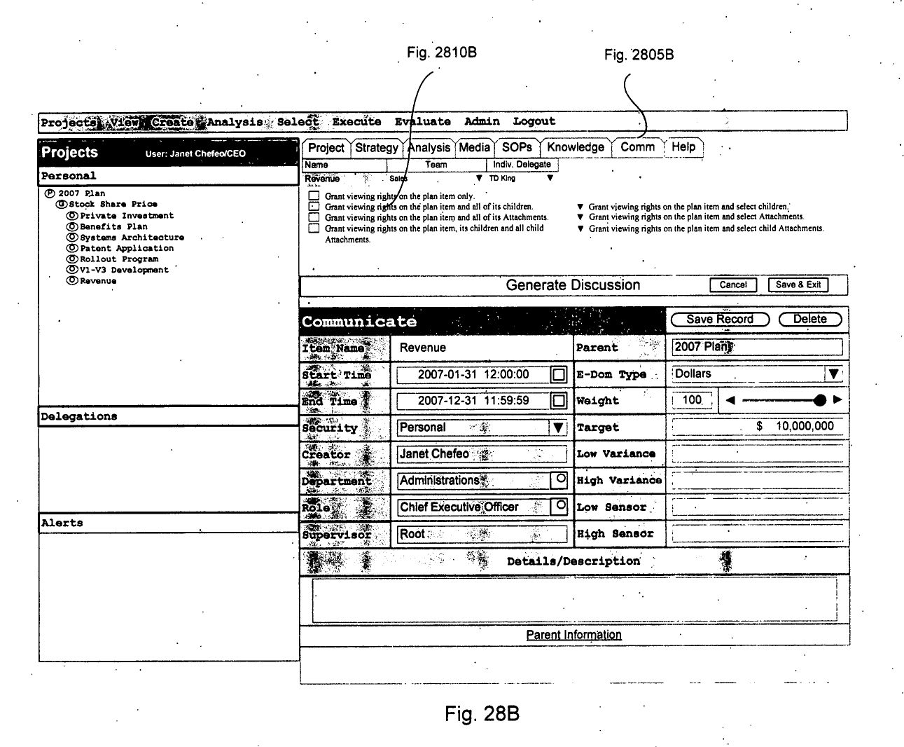

Comm. Comm is an abbreviation for communication. The Comm Tab (FIG. 2805) offers the functionality (FIGS. 28A & 28B) to communicate with another user about a specific plan item. When a user communicates with other team members they are granting viewing rights for the item to users that are identified on a distribution list. In the process of configuring the communication item (FIG. 2810B), users can elect to:

1. Grant viewing rights on the plan item only.

2. Grant viewing rights on the plan item and all of its children.

3. Grant viewing rights on the plan item and select children.

4. Grant viewing rights on the plan item and all of its Attachments.

5. Grant viewing rights on the plan item and select Attachments.

6. Grant viewing rights on the plan item, its children and all child Attachments.

7. Grant viewing rights on the plan item and select child Attachments.

Users that are invited into collaboration (target collaborators) on plan items through the Comm tab, the target collaborator possesses the functionality to create new plan items. When target collaborators create new plan items, regardless of their location with respect to the plan item being “discussed”, the target collaborator is identified as the Creator of the new plan item. The user that initiated the discussion (source collaborator) is listed as the Owner of all items related to the collaborative event.

Stage 1: Create, Phase b) Plan

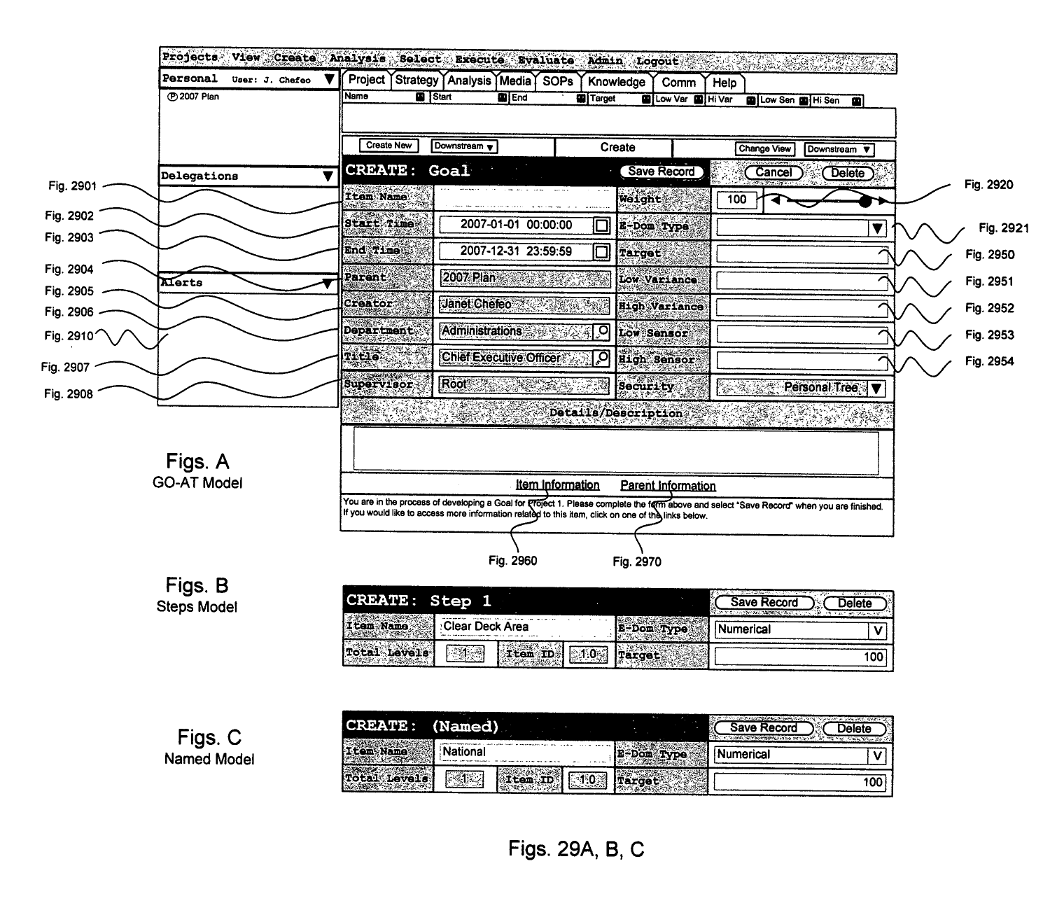

Upon completing each of the required Profiles, the Initiator of a project enters into the “Create/Plan” (FIG. 3) phase of the Plan Development Process. Users create plan items using Plan Item Development Forms (FIG. 29).

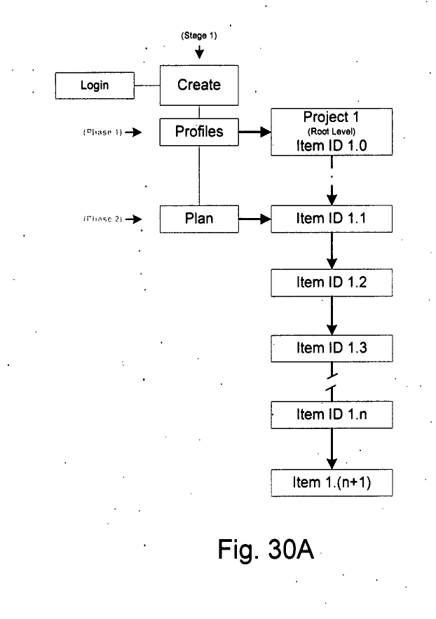

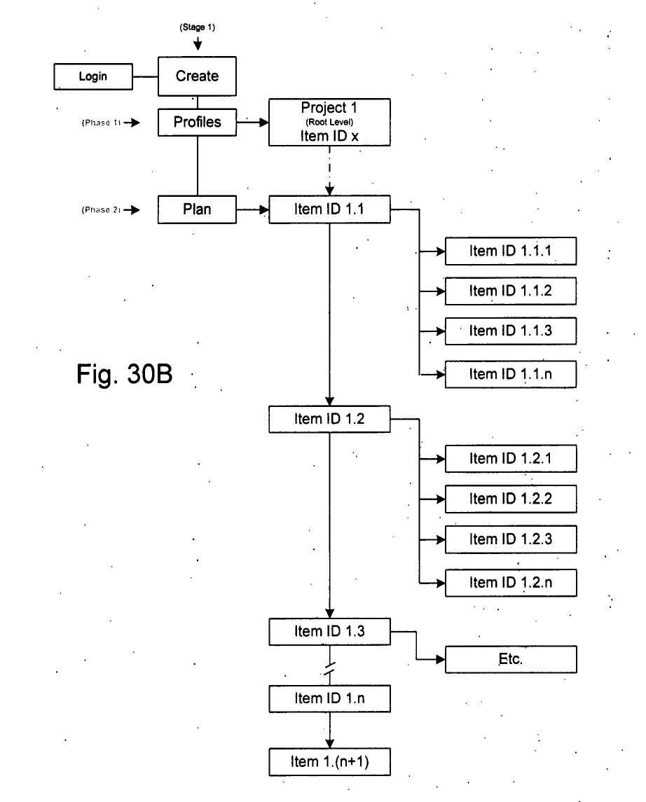

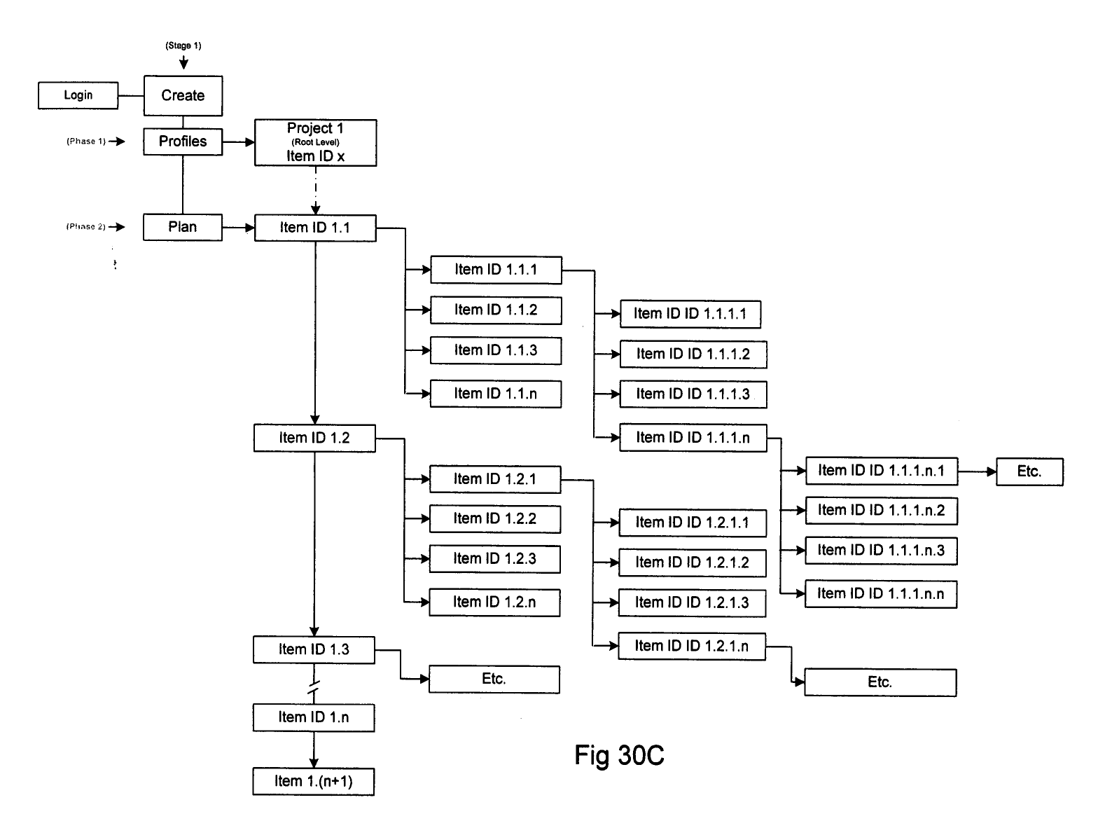

Item Name. The first field listed on a Plan Item Development Form is titled Item Name (FIG. 2901). A unique identification number is assigned to the Item Name (FIGS. 30A-C) by the system so that the plan item and the information placed on the form can be stored and retrieved effectively. This identification number is invisible to the user.

Start Time. Start Times (FIG. 2902) on a form represent the time the item is to be executed. When this date arrives:

1. The user is sent an Alert (FIG. 2910) notifying them that the Start Date for the item has begun.

2. Measurement of the item is now performed by the system utilizing all Edometers (FIG. 2950) resident to the item, its parent, and children.

3. Start Times also trigger Advance Notification Warnings (FIG. 2910) based on the parameters set by the user.

End Time. End Times (2903) on a form represent the end of the time which has been allotted for achievement of the Target set for the item. When this date arrives:

1. The user is sent an Alert (FIG. 2910) notifying them that the End Date for the item has arrived.

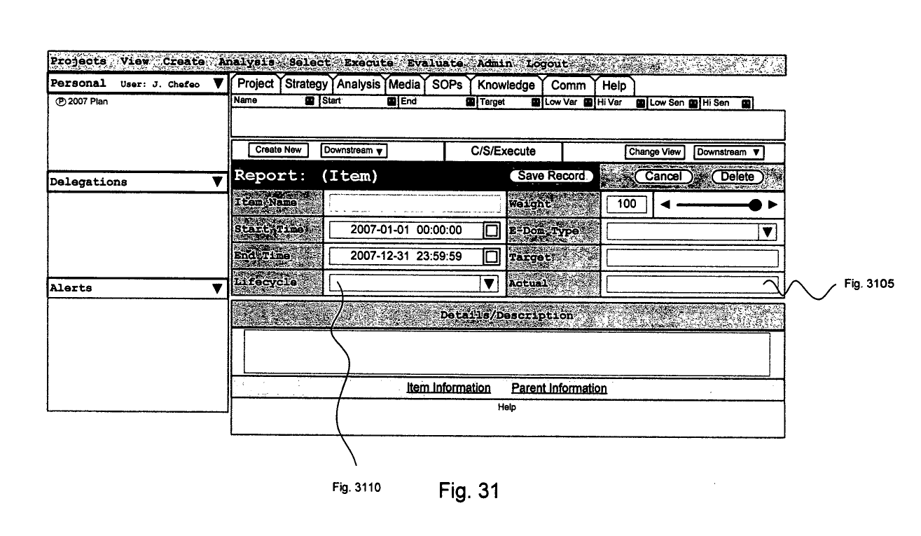

2. If this is the lowest level in the users plan, they are sent a Report Form (FIG. 31) to be completed with a field which communicates the actual result (FIG. 3105) achieved for the item. The user is also provided with a Lifecycle (FIG. 3110) drop-down box which communicates whether the report represents a final report or whether there is a need for delaying the submission of the report.

Parent. The Parent field (FIG. 2904) lists the Item Name corresponding with the identification number the item was created underneath. Each plan item has only one Parent. This field is set by the system.

Creator. The Creator field (2905) lists the User Name corresponding with the identification number of the project participant that first created the item. This field is set by system. It cannot be changed.

Department. The Department field (FIG. 2906) is available to communicate the functional area the user works in.

Title. The Title field (FIG. 2907) exists to communicate the role the user plays in the organization or project.

Supervisor. The Supervisor Field (FIG. 2908) communicates the personnel reporting structure of the item. This field is set when the Management Profile is created. It is used in conjunction with Edometers to report achievement and results.

Weight. The Weight field (2920) is used to increase or decrease the numerical values associated with Target numbers.

Edom Type. Edom Type (FIG. 2921) communicates the type of value that users are seeking to achieve. Once an Edometer Type is set the children of that item must also be set to the same value.

Target. The Target (FIG. 2950) of an item represents a numerical value the user is seeking to achieve. The Target is used as an element by any parent and child items as part of the Edometer sub-system to measure the progress and outcome of the project, and to communicate this information to project participants via the Dashboard.

Plan Variances. Plan Variances (FIGS. 2951 & 2952) introduce the means for notifying team members when Plan Item Targets are tracking below or above a specified amount. Two types of Plan Variances are made available. A Low Plan Variance (FIG. 2951) introduces the means for notifying team members when a Plan Item is tracking below a specified amount. A High Plan Variance (FIG. 2952) introduces the means for notifying team members when a Plan Item is tracking above a specified amount. Triggering a Low or High Plan Variance is commonly referred to as breaching a plan variance.

Personal Sensors. Personal Sensors (FIGS. 2953 & 2954) introduce the means for creating personal alerts that inform plan owners when a Plan Variance is tracking below or above a specified amount. Two types of Personal Sensors are made available. A Low Personal Sensors (FIG. 2953) introduces the means for creating a personal alert when a Plan Variance is tracking below a specified amount. A High Personal Sensor (FIG. 2954) introduces the means for notifying team members when a Plan Variance is tracking above a specified amount.

Item Information. Clicking on the hyperlink labeled Item Information (FIG. 2960) brings up all additional fields related to the item that the user has the authorization to view.

Parent Information. Clicking on the hyperlink labeled Item Information (FIG. 2970) brings up all additional fields related to the item that the user has the authorization to view.

Standard Planning Tree Rules. There are several rules common to Planning Trees. Among them:

1. Plans created by users continue to be listed on their Personal Planning Tree until they Delegate a Plan Item from it.

2. Once a user delegates any plan item from a plan the entire project is moved to the Delegations Planning Tree.

3. Users can Delegate Plan Items to themselves.

Standard Form Management Rules. There are several rules common to all Forms created on the system. Among them:

1. The Start Date and End Date for all child forms must fall within the Start Date and End Date of its Parent Form.

2. When a user saves a Plan Item Development Form the Item Name placed in the Item Name field is listed on the appropriate Planning Tree (FIGS. 410 & FIG. 420). Users reentering the system are also presented with a list of Item Names on their Planning Trees.

3. The Targets on Children Forms at the same planning level must sum to equal the Target on its Parent Form.

4. The fields on all forms can be adjusted to meet the needs of the project participants.

A standard element on the dashboard is the inclusion of a percentage measurement.

Plan Item Attachments

Attachments to Plan Levels. The same Attachments (FIG. 9) described earlier in this Description relating to adding Attachments to Project Profiles can be added to all new and subsequent plan items created by users. Creating and adding Attachments to a plan item is accomplished by first clicking on the desired plan item on the Planning Tree (FIG. 412) the Attachment is to be made to. Next the user follows the same procedure outlined earlier in this Description in the section titled “Creating New Attachments”. Accessing lists of Attachments made to new and subsequent Plan Items is accomplished by fist clicking on the Plan Item on the Planning Tree containing the pertinent Attachments. Next the user follows the same procedure outlined earlier in this Description in the section titled “Accessing Attachment Lists”.

Dialogue Box. In each instance where a user desires to create a new plan level, they are presented with a Dialogue Box, such as that in FIG. 6A & 6B, which gives the user the opportunity to designate the level of the new plan item they wish to create. Users can:

1. Create a new Parallel Plan Item.

2. Create a new Child Plan Item.

Plan and Participant Design Logic

The present invention is designed to provide changing numbers of project participants with a logical, flexible method for creating multi-level plans. Accordingly, it introduces the ability to create as many plan levels as is necessary to meet the needs of the project. Given the appropriate storage mechanisms, this process represents the ability to continue adding users and plan level increments at will. An environment such as this requires that before creating an underlying plan level, a solution set for upper plan levels is arrived at. This approach prevents inefficiencies in plan development by eliminating the possibility of creating solution sets for lower level plan items which, upon analysis, are subsequently discarded. As such, it is necessary for project participants to enter into the Select Stage so they can determine the solution set for upper plan levels before creating the next level of the plan.

Stage 2: Select. Upon creating more than one Plan Item or Attachment, users are provided with the functionality allowing them to enter into Stage 2 of the Plan Development Process (FIG. 3), namely the Select stage. This functionality is provided to them by adding an active “S” hyperlink to the Selector Bar Hyperlinks (FIG. 461). The Select stage is engaged by clicking on the Selector Bar Hyperlink labeled “S”. This will cause the system to reconfigure the Drop-Down Boxes and Selector Bar Buttons to accommodate the phases and processes resident to this Stage of the program.

Common Select Stage Elements. Several functional elements are common to all phases within the Select stage. Among them:

1. Each Phase in the Select stage is initiated by first choosing the desired phase from the Right Drop-Down Selector (FIG. 463), and then clicking the Engage Button (FIG. 465).

2. Each Phase in the Select stage contains a unique interface that accommodates the processes inherent to that phase. Although the interface is unique to each phase, there are several features and buttons that are common to all interfaces employed by the user, namely the Group (FIG. 3210) and Pivot Bar Hyperlink (FIG. 3220) features, and the buttons labeled Reset (FIG. 3240), Cancel (FIG. 3215), and Save & Exit (FIG. 3250). The Group feature (FIG. 3210) provides a user with the ability to break the list of items shown on the Pivot Screen (FIG. 450) into the number of groups specified by the user. Clicking on the “C” hyperlink (FIG. 3220) presents the user with a dialogue box giving the user two options. The first option the user is given is to save the changes they've made. The second option is to discard the changes they've made and return the items to the position they occupied since the last time the Save feature was engaged. The Reset Button (FIG. 3240) places each item in the position they occupied the last time the Save feature was engaged. The Cancel Button (FIG. 3215) exits of the user out of the phase. The Save & Exit (FIG. 3250) button saves all changes the user has made and exits of the user out of the phase.

The Select stage of the Plan Development Process includes six phases (FIG. 3)), namely Prioritize, Deactivate, Propose, Vote, Choose, and Delegate.

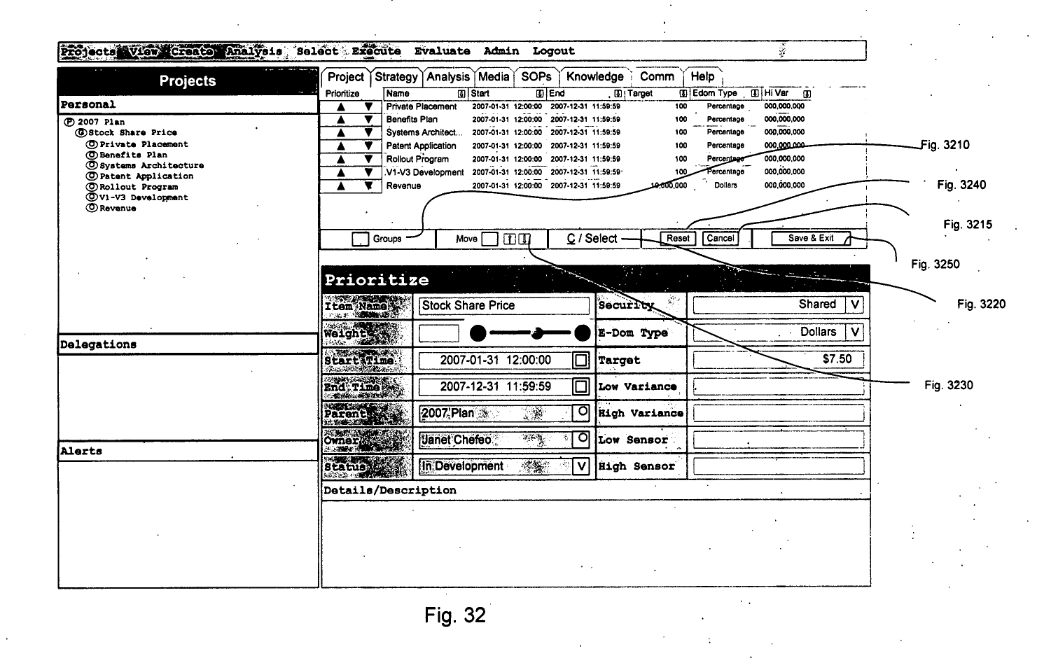

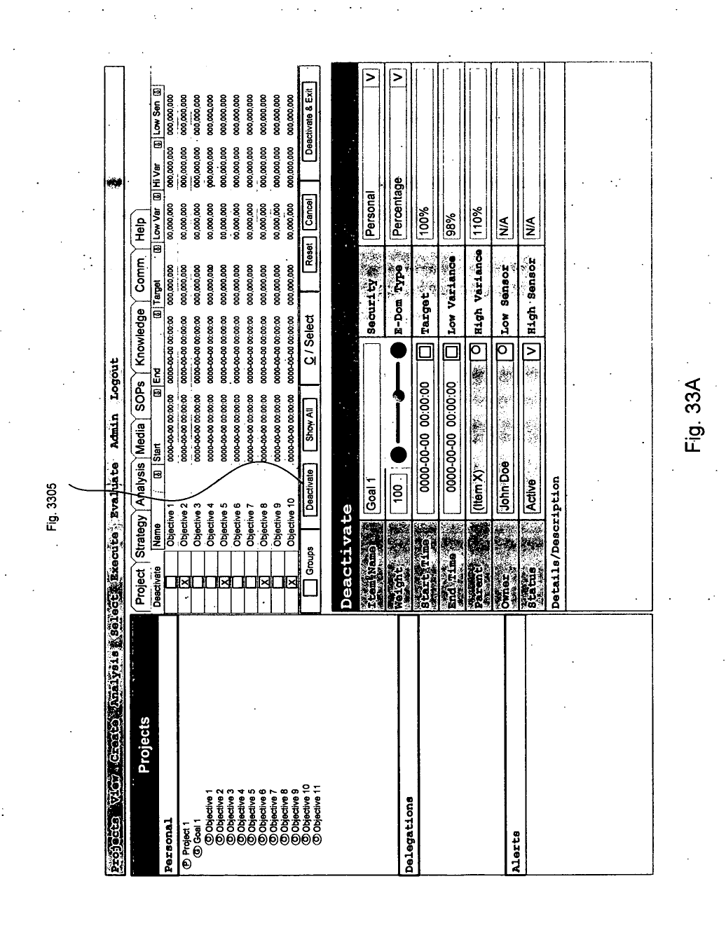

Prioritize. The Prioritize Phase is designed to provide users with the ability to order plan options in the Pivot Screen (FIG. 450) according to their opinion of which hold the most promise for helping achieve the Target of its Parent and the plan in general. This Phase also gives users the opportunity to list Attachments in order of personal preference. Prioritization is performed by first engaging the Prioritize Phase (See Common Select Stage Elements, #2). This provides the user with the Prioritize interface (FIG. 32). The Move feature (FIG. 3230) provides the ability to move plan items up or down according to the number of increments specified by the user.

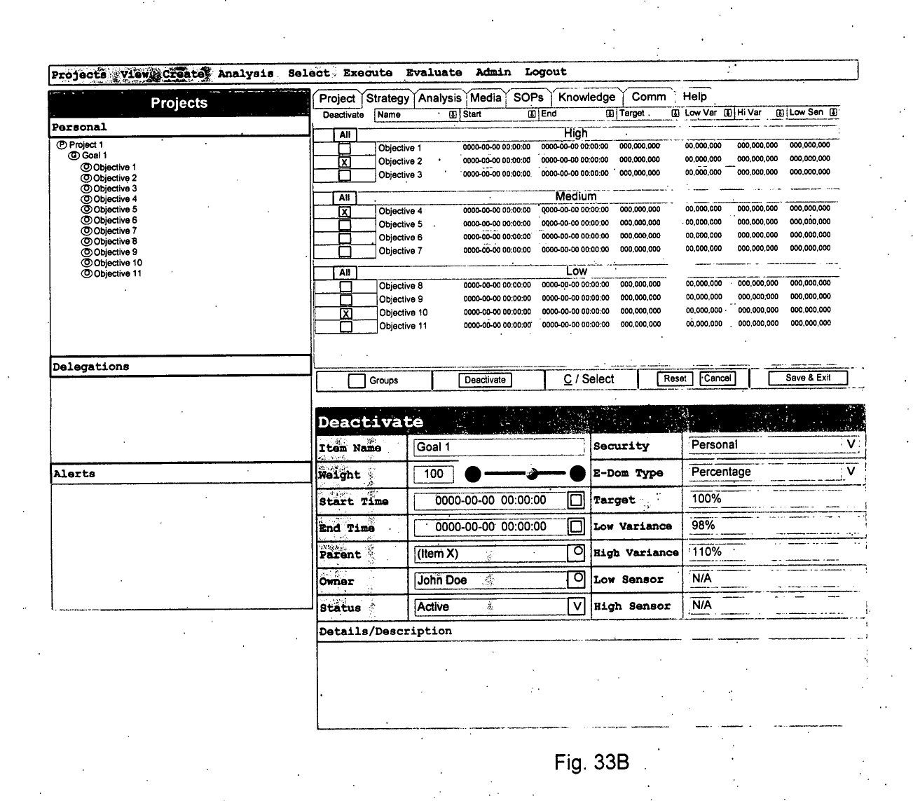

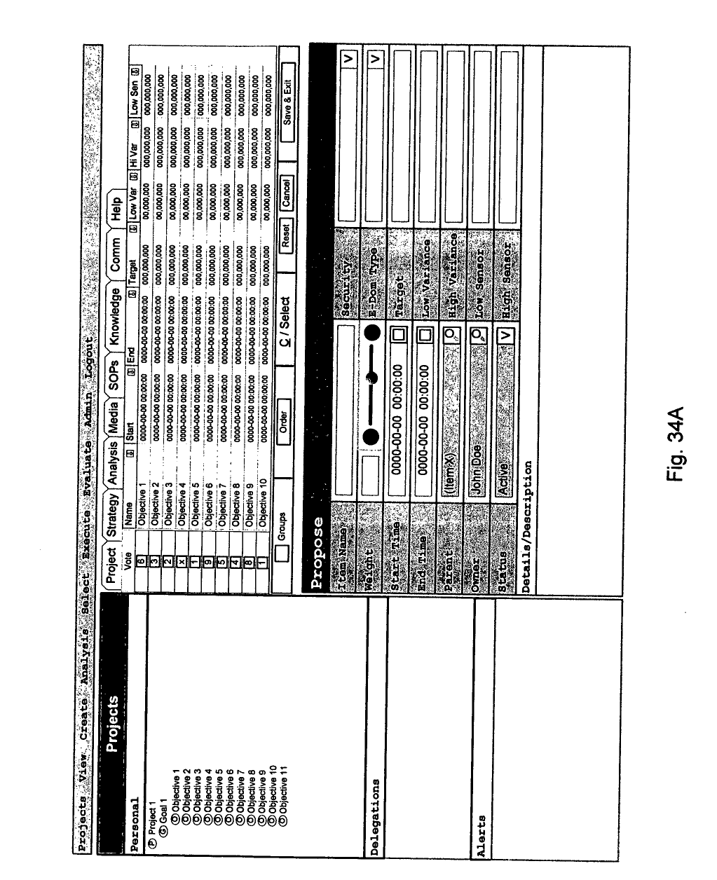

Deactivate. The Deactivate phase is designed to reduce screen clutter by hiding less desirable plan options from the Pivot Screen. It is important to note that deactivated options are not deleted. This is an important distinction as it insures that items remain available for recall at a later time. This phase also gives users the opportunity to Deactivate Attachments that are linked to plan items. Deactivation is performed by first engaging the Deactivate Phase of the Select stage (See Common Select Stage Elements, #2). This provides the user with the Deactivate interface (FIGS. 33A & 33B). The Deactivate Button (FIG. 3305) provides the ability to remove Plan Items from the screen.

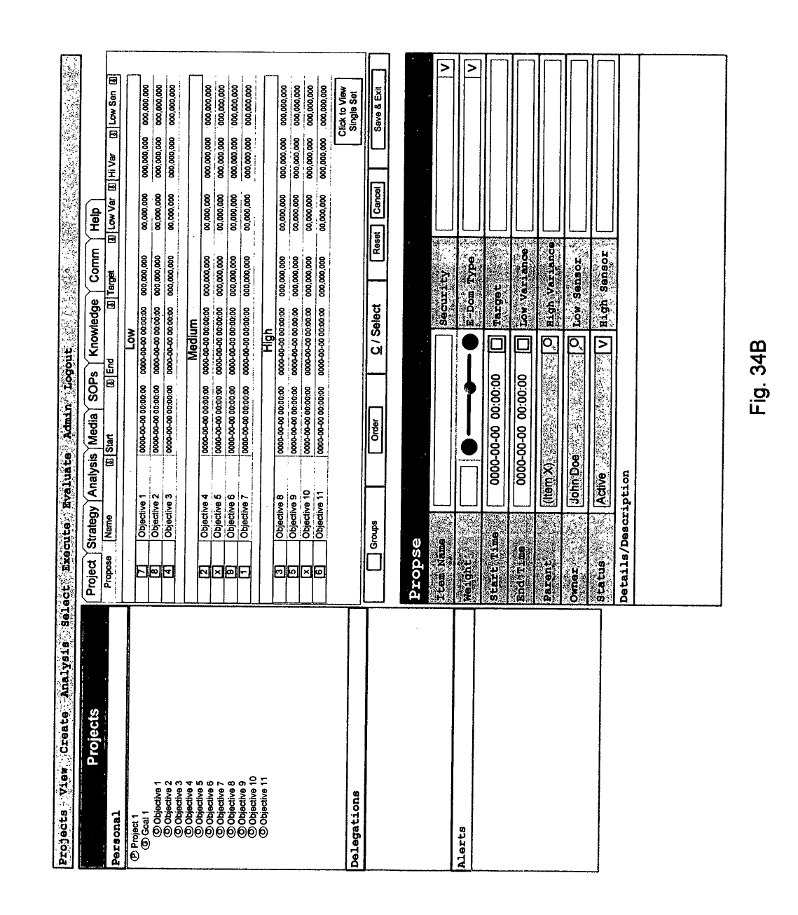

Propose. The Propose phase is designed to provide users with the ability to submit lists of items to other users, such as supervisors, for the purposes of offering suggestions on the best plan options that will help achieve the plan's targets. From a functional standpoint, this process amounts to a user authorizing another user, or users, to view a list of plan items. In this phase, Attachments can also be included as part of the proposal using a process similar that which was used in FIG. 2810B. The Propose phase is enacted by first engaging the Propose Phase of the Select stage (See Common Select Stage Elements, #2). This provides the user with the Propose interface (FIG. 34).

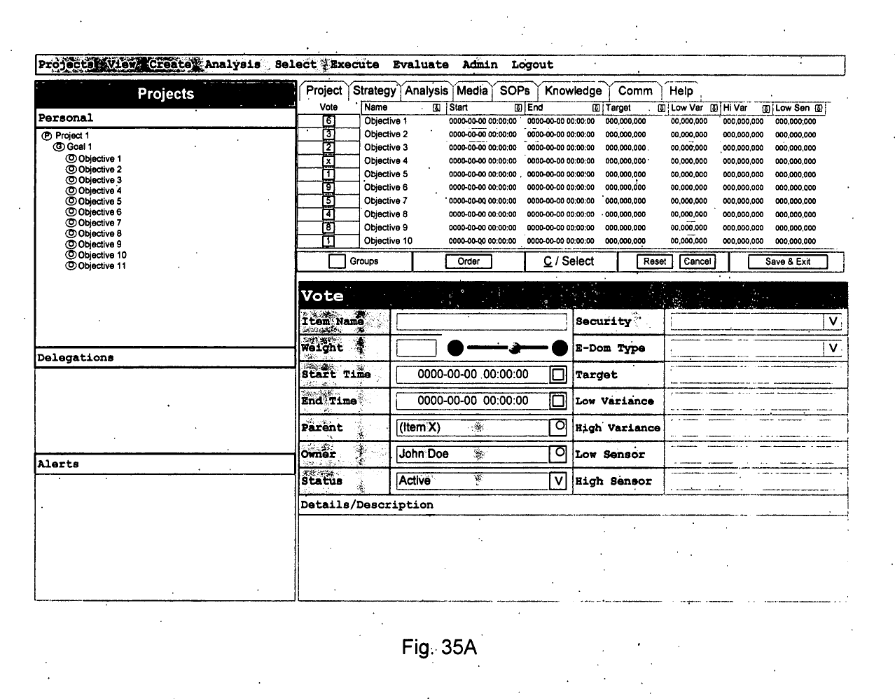

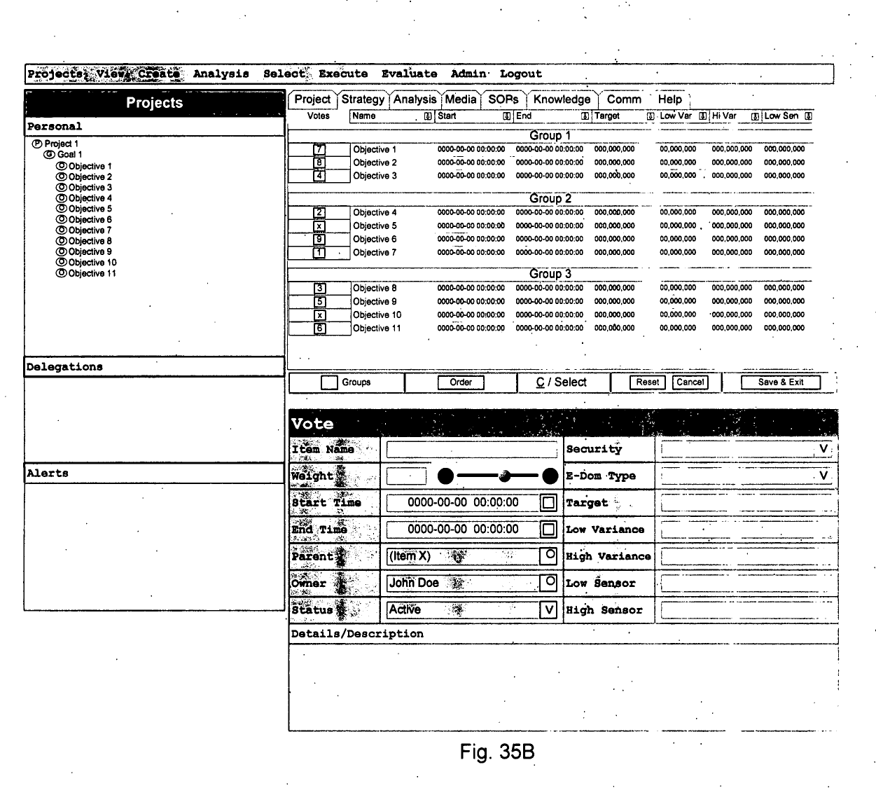

Vote. The Vote phase is an optional Select stage element. The Vote phase designed to provide managers and supervisors of teams with feedback from users on which plan options offer the most promise for reaching the plan's targets. In addition, the Vote phase offers project participants with a public forum in which to select the plan that will be executed. The Vote phase is distinct from the Propose phase in that plan options from the entire team population can be viewed by users and then voted on, versus users creating proposals from their personal list of options only. Voting is performed by first engaging the Vote Phase of the Select stage (See Common Select Stage Elements, #2). This provides the user with the Vote interface (FIG. 35).

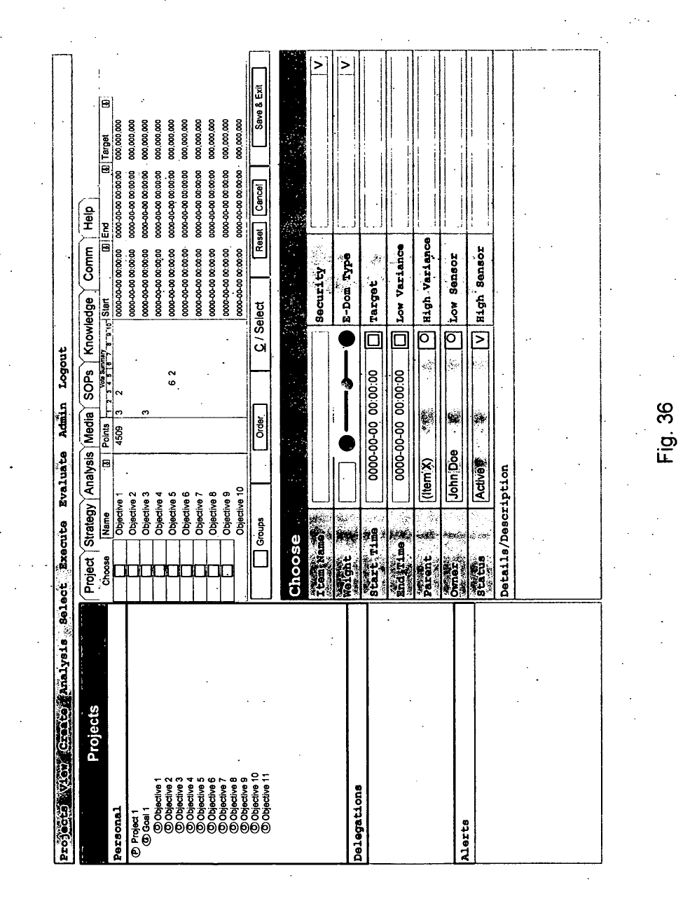

Choose. The Choose phase is designed to provide the opportunity to make final determinations pertaining to the solution path that will be followed to achieve the targets set in the plan. The Choose phase is enacted by first engaging the Choose Phase of the Select stage (See Common Select Stage Elements, #2). This provides the user with the Choose interface (FIG. 36).

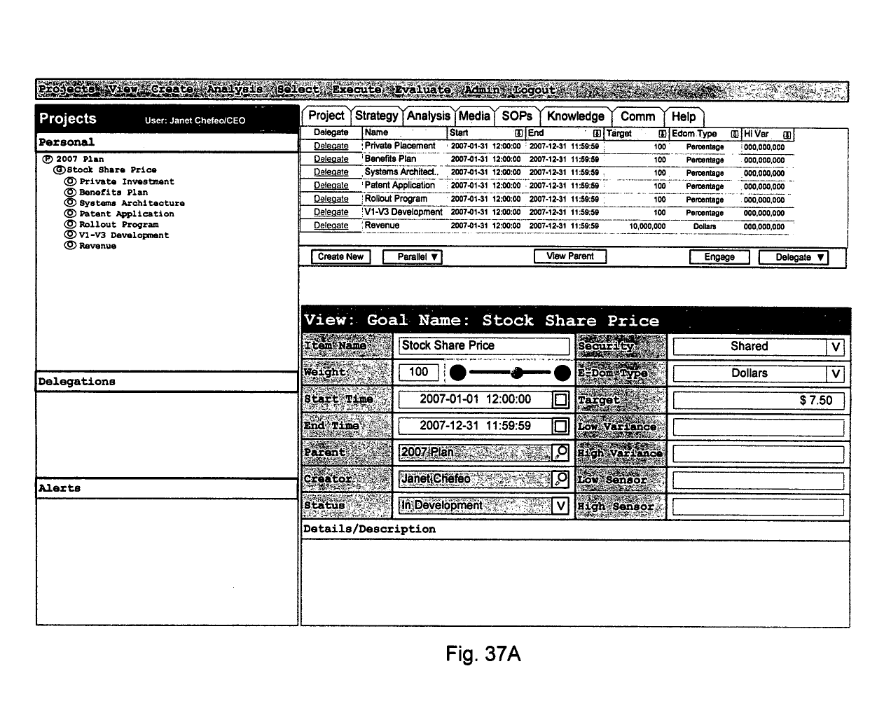

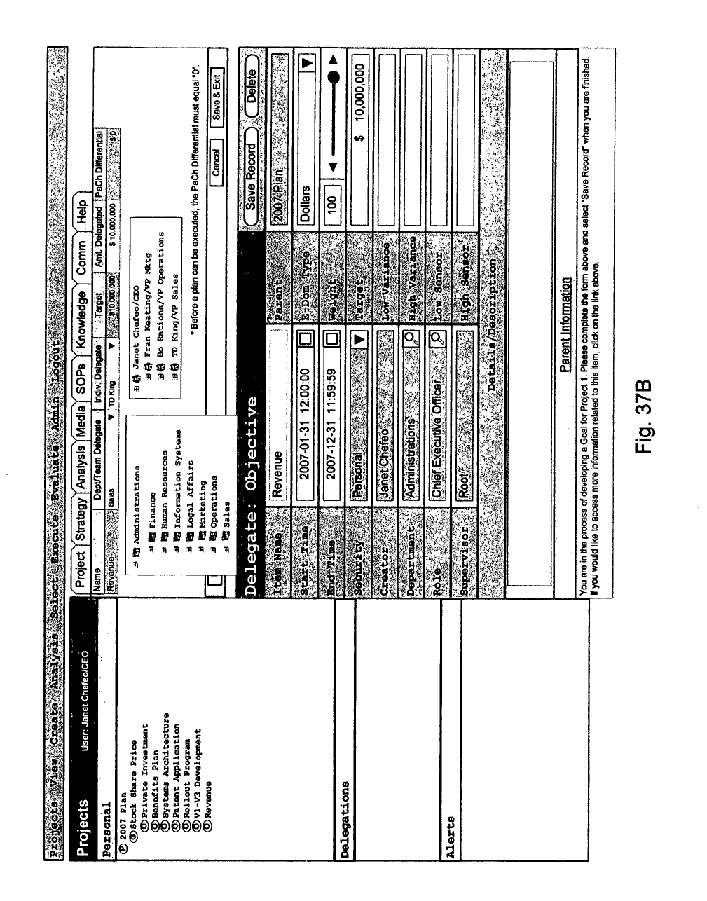

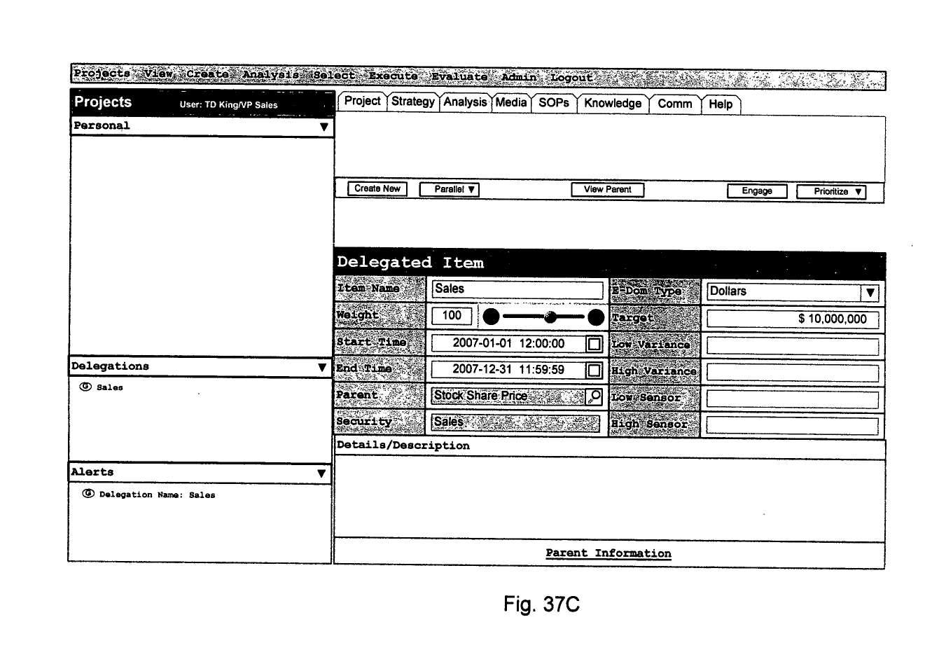

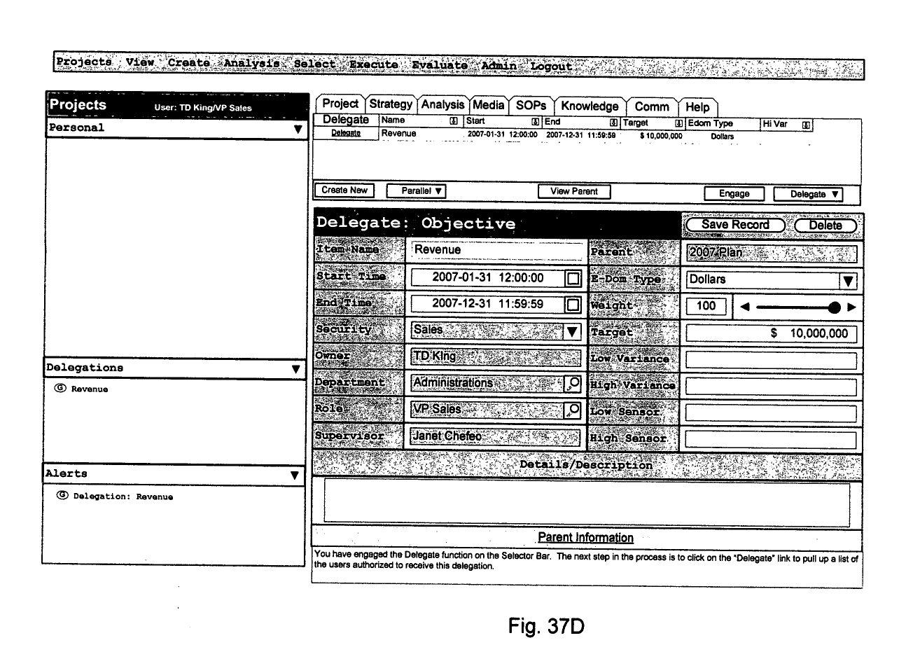

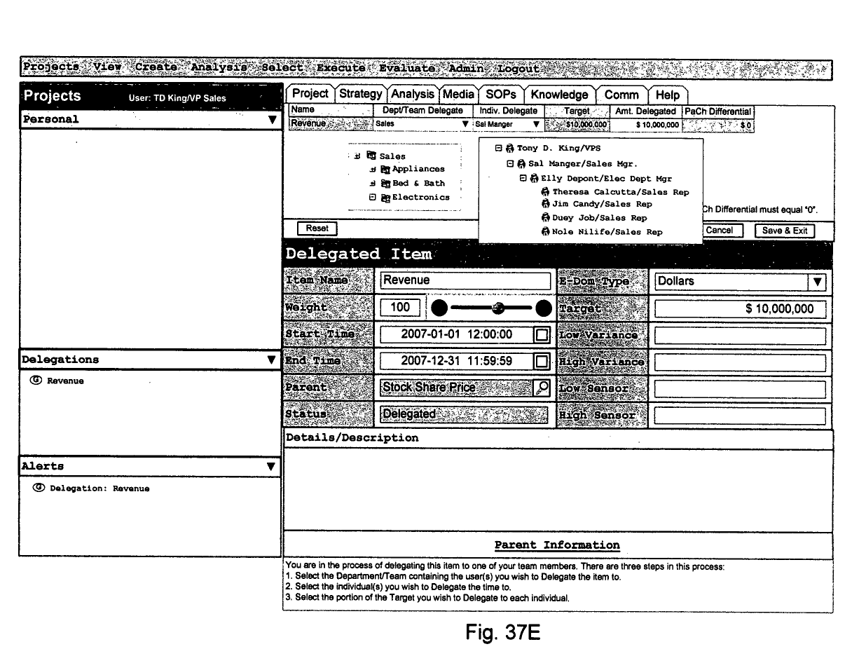

Delegate. The Delegate phase is designed to provide supervisors with the ability to assign plan items to users. This step effectively distributes accountability for achieving plan items to the individual or team that receives the delegation. In a new delegation, this event causes the system to create a field name called Owner. The target of the delegation is then assigned to the Owner Field by the system. The target of the delegation remains listed in this field unless they delegate the item to another user. Creating and delegating a child for the plan item effects no change on the user listed in the Owner field of the original plan item. The Delegate phase is enacted by first engaging the Delegate Phase of the Select stage (See Common Select Stage Elements, #2). This provides the user with the Delegate interface (FIGS. 37A-E).

Any plan item that is delegated from a user's Personal Planning Tree causes the entire project to be permanently moved to the Delegations Planning Tree of the source of the delegation. Accordingly, the target of the delegation also receives the item in their Delegations Planning Tree.

Plan Development Logic Revisited

Once the Select stage is completed, project participants are left to decide whether a new level is needed in the plan to strengthen accountability and to enhance the likelihood for the plan's success. The decision to create a new plan level is at the project participant's discretion. The present invention is designed as an iterative tool. It is designed to facilitate continuous improvement. If time limitations inhibit participant's ability to develop addition levels in a plan, it is suggested they proceed to the Execution stage. If, at the completion of the project, the targets set at the outset of the plan are not achieved, that often suggests a need for greater accountability, which suggests a need for additional levels in the development of a plan.

Limited Plan Levels. Limited plan levels introduce the opportunity to create plan items that are measured separately from the rest of the plan. Limited Plan Levels are designed to measure contributions made by “external” parties without corrupting other areas of the plan. Limited plan levels contain inherent flexibility in that they can be delegated to other users through child plan items, or they can be applied to a single user. Limited plan levels also introduce the opportunity to create a “dotted line” reporting structure into a plan. This technique is employed by creating a Limited plan level item for a user where a duplicate exists for another user in the plan. In this instance, the measurement is not passed upstream to a parent plan item. Achievement of the item is used merely to gauge the participation of the user in, for example, another department.

Stage 3: Execute. The Execute Stage (FIG. 3) begins once the desired number of plan levels have been created and delegated.

Stage 3, Phase 1: Prepare. The Prepare phase of the Execute stage exists to reconcile the plan's measurement system before commencing with the plan. Prior to executing a plan, the Targets of all children items underlying parent items must sum to equal the Target of their Parent (FIG. 3710). Reconciliation of a plan amounts to auditing the plan to make sure mathematical integrity exists from the top levels of the plan extending to the lowest levels in the plan. The system facilitates the reconciliation process by providing users with Alerts (FIG. 430) listing the location of problem areas. A second element inherent to the Prepare phase involves incorporating Plan Variances and Personal Sensors into the Edometers structure. Plan Variances are set at the highest levels of the plan and automatically filter down through child levels. Personal Sensors are set by individual project participants. Personal Sensors can be set by configuring the Low and high Sensors located at the highest level in an individuals plan and allowing them to filter downward to the child items underneath them, or they can be set individually.

Advance Notifications. Another element inherent to the Prepare phase involves setting Advance Notifications to their desired levels. The purpose of Advanced Notifications is to give users time to prepare for the beginning of a plan item. Advance Notifications create Alerts that are triggered prior to a plan item's start date. Each user can configure the length of time prior to the start date that an Alert will be sent.

Engage. The Engage phase (FIG. 3) exists to communicate to users that the time has come to achieve the Targets created in their plan. The Engage stage begins when the Start Date (FIG. 610) for a project is reached. Accordingly, the Engage phase for all plan items begins when their start dates are reached. When the Start Date for a plan item is reached, an Alert is sent (FIG. 430) notifying the owner of the item of this event. Clicking on the Alert presents the owner of the item with a record of the plan item in the Forms Area (FIG. 480). Project participants can configure the program so that the behavior of the text on the Planning Tree of an active plan item is altered when the start dates for items are reached.

Report. The Report phase exists to communicate to users that the End Date for achieving a plan item has been reached. The Report stage takes place when the End Date for a plan item is reached. When the End Date for an item is reached, an Alert is sent (FIG. 430) notifying the owner of the item of this event. Clicking on the Alert presents the owner of the item with a Report Form (FIG. 31) in the Forms Area (FIG. 480) of their Interface. Project participants can configure the program so that the behavior of the text on the Planning Tree of an active plan item is altered when the start dates for items are reached.

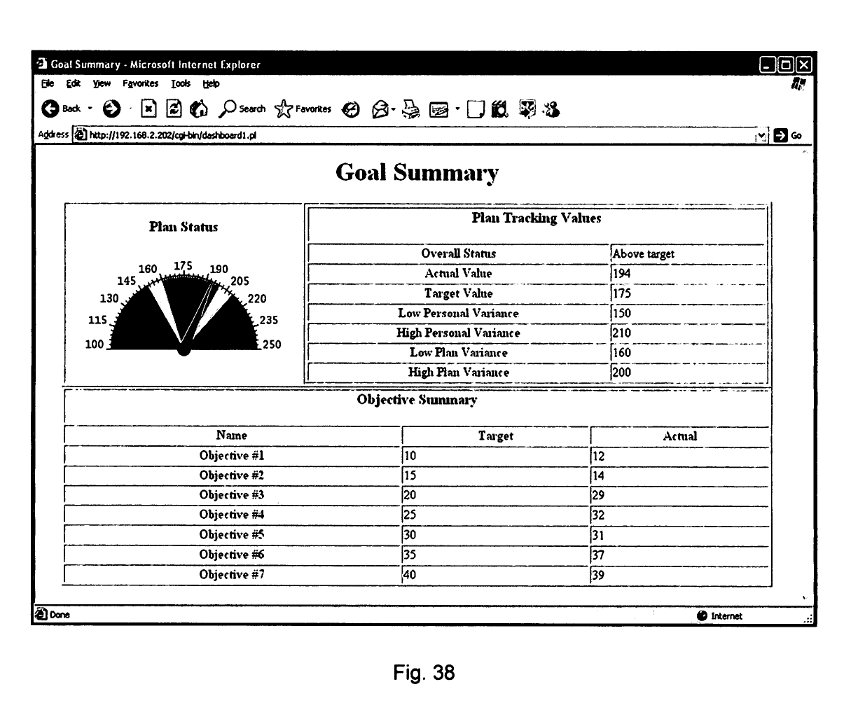

Dashboards. Dashboards exist to communicate plan item outcomes to project participants with the authorization to view this information. When a user completes and saves a Report Form, the data from it is used to create a Dashboard (FIG. 38). Dashboards are capable of providing a complete picture of each level in a plan. Dashboards are capable of communicating the current state of plan item achievement in projects in which End Dates have not been reached. Dashboards are capable of communicating plan item results in projects whose End Dates have been reached. Various types of mathematical calculations can be applied to Report Form data and communicated through Dashboards. Accordingly, the configuration of the information placed on a Dashboard can be adjusted by users with the authorization to do so.

Stage 4: Evaluate

The Evaluate Stage (FIG. 3) begins when the End Date for a Project has been reached. Assess. The first phase in the Evaluate Stage is the Assess Phase (FIG. 3). The Assess Phase exists to provide individual users with an opportunity to study their personal performance in the project. The Assess Phase also exists to provide project participants with an opportunity to study the performance of the entire population of users involved in the project. To facilitate assessment processes, users are provided with a variety of reports that are accessible through the Report Menu (FIG. 401). The items listed on the Report Menu vary according to the viewing rights afforded each user.

Improve. The second phase in the Evaluate Stage is the Improve Phase (FIG. 3). The Improve Phase exists to provide users with an opportunity to decide how to improve the outcomes achieved in the last iteration of the plan. Methods for improving a new iteration of the plan are recorded on a Plan Item Development Form (FIG. 29). All information created in previous iterations of the plan, to include Deactivated items and their Attachments, is made accessible to users with the authorization to view this information.

Guiding users to the Improve phase, and creating new plan items using Plan Item Development Forms, effectively returns users to the Create stage. At this point they are beginning a new iteration of their plan.

Ancillary Program Information

Knowledge. The Knowledge Tab (FIG. 446) provides users with a method for searching for information contained in projects. Users can limit searches to specific Plan Levels, Attachments, Attachment Categories, and Users. Users can hone searches by inputting keywords that the system will apply against searchable documents. Items that contain the keywords inputted by the user will be presented to users according to the name of the item given to it by the user that created it.

Screen Navigation. Various screens presented to users in the present invention are user configurable. For example, the Pivot Screen can be adjusted to accommodate user preferences so that it includes or excludes fields that are attached to each plan item. As another example, the Planning Trees may contain lengthy item names that extend beyond a viewing area. In situations where names are too lengthy, or more fields or items are desired by the user than can be shown on the screen, standard interface scroll bars are provided on the right side and bottom of the screen to facilitate navigation.

Choose Options. The Select/Choose phase is designed with the flexibility in mind to employ different methods for determining the specific options used in the final solution set. A variety of approaches can be devised and employed by users to help them determine the specific options used in the final solution set. As an example, an approach can be employed whereby descending point values are attached to a multiple item list. Using this approach, in a 10 item list, a first place vote might be given a value of 10 points, and a last place vote might be given a value of 1 point. The total number of points given to the item would be calculated by adding the points given to that item by all users. The items with the highest point values would be placed in the final solution set. An example of another approach that can be employed is to place the item that receives the most first place votes in the final solution set.

Security Rules & Configuration

Only the Owner or Creator of an item can edit it. A record is made of all plan item edits.

I claim:

1. A method for developing unique project-based plans which are extensible in their ability to
accept new plan items at any point in time which reside underneath an existing plan item.
accept new plan items at any point in time which reside at the same level as other plan items.
accept new project participants at any point in time.

2. The method for claim 1, further including the following steps:
attaching new plan items to the creators of said plan items.
attaching a Start Date to each plan item.
attaching a target number to each plan item prior to the arrival of the Start Date for said plan item.
attaching an End Date to each plan item.

3. The method of claim 1, further including the following steps:
attaching long-term strategies to plan items.
attaching medium-term strategies to plan items.
attaching short-term strategies to plan items.
attaching questions asked by project participants to plan items wherein
attaching research to questions that responds to questions asked by project participants.
attaching research performed by project participants to plan items.
attaching analytical templates to plan items.
attaching audio to plan items.
attaching web blogs to plan items.
attaching images to plan items.
attaching text files to plan items.
attaching websites to plan items.
attaching video to plan items.
attaching analytical templates to plan items.
attaching standard operating procedures to plan items.

4. The method of claim 1, further including the step of delegating plan items to project participants in such a manner as to assign the plan item to a new individual or team participating other than the current owner of the plan item, effectively transferring responsibility for achieving the item to the new individual or team in which the plan item is assigned.

5. The method of claim 1, further including the step of giving project participants the opportunity to electronically communicate plan option preferences, calculating said preferences, and selecting a specific number of plan items by adding those preferences together and choosing the plan items based on the plan items which accumulate the highest number of preferences.

6. The system of claim 2, wherein an actual achievement number is attached to the plan item by the owner of the item upon arrival of the End Date for said plan item.

7. The method of claim 2, further including the step of performing calculations at any point in time against actual achievement numbers in a horizontal and vertical manner to produce summary calculations which represent:
the current achievement status for the plan item if the End Date for the
